(19) United States
(12) Patent Application Publication
(10) Pub. No.: US 2014/0111045 A1
(43) Pub. Date: Apr. 24, 2014

(54) ROTARY DRIVE

(71) Applicant: Ernst Goepel, Gauting (DE)

(72) Inventor: Ernst Goepel, Gauting (DE)

(73) Assignee: Andreas KAPPEL

(21) Appl. No.: 14/117,960

(22) PCT Filed: May 15, 2012
(86) PCT No.: PCT/EP2012/002085

§ 371 Date: Nov. 15, 2013

(30) Foreign Application Priority Data
May 15, 2011 (DE) 10 2011 101 436.9

(51) Int. Cl. H02K 7/116

(52) U.S. Cl. CPC H02K 7/116
USPC 310/83

(57) ABSTRACT

A rotary drive has a first body with a toothing system that runs along a first circular circumference about a first rotational axis, a second body with a toothing system that runs along a second circular circumference about the first rotational axis, and a converter with a first toothing system that runs along a circular circumference at a first spacing about a second rotational axis, and a second toothing system that runs coaxially with respect to the first toothing system along a circular circumference at a second spacing, and having at least two actuators with directions of action which are not parallel to one another, by which actuators the converter can be displaced in each case in one direction. The converter can be displaced by the two actuators such that the second rotational axis runs along a circular path around the first rotational axis.

The present invention relates to an electric motor, referred to below as rotary drive, in particular an electric rotary drive which is easy to control, is driven by electro-magnetic fields, is overload-proof and has a high torque density.

Electric motors according to the prior art, as described, for example, in EP1324465B1, EP0670621B1 and EP0901710B1, have rotors which can be made to rotate by electro-magnetic fields. The torques of such electric motors are low. High motor power levels are achieved by high rotor rotational speeds. For this reason, electric motors are often combined with multi-stage transmissions, with the result that the electro-mechanical efficiency worsens and the installation space, weight, transmission play and noise emission increase. The high rotational speeds of electric motors and the high moments of mass inertia of the rotors also have an unfavorable effect on the dynamic behavior. With the exception of stepping motors, electric motors require additional sensors for detecting the rotational speed, attitude or load. However, stepping motors have a limited resolution capability and disruptive ratchet torques.

The object of the present invention is to make available an electric motor having a torque density, dynamics, actuating accuracy and operational stability which are high compared to the prior art. In particular, the motor shaft is to be advantageously capable of being moved into defined positions by applying electrical control signals and/or of being rotated in a defined fashion in predefined rotational directions with predefined rotational speeds by the electrical control signals.

The object is achieved by means of the rotary drive as claimed in claim 1, the method for operating a rotary drive as claimed in claim 19, the method for detecting load torques in a rotary drive as claimed in claim 23 and the method for detecting the position and attitude of a rotary drive as claimed in claim 24. The respective dependent claims specify advantageous developments of the rotary drive according to the invention and of the methods according to the invention.

According to the invention, a rotary drive is specified which has a first body and a second body, wherein the first body has a toothing system of the first body which runs around along a first circular circumference about a first rotational axis, and the second body has a toothing system of the second body which runs around along a second circular circumference about the first rotational axis. The toothing systems of the first body and of the second body can therefore be considered to be coaxial. In this context, the toothing systems of the two bodies can run in a common plane or in different planes, which are preferably parallel to one another. The toothing systems of the first and second bodies can be formed by a multiplicity of teeth arranged equidistantly with respect to the first rotational axis, wherein given identical points of each tooth with respect to the first rotational axis they are each at a constant distance within a given body. The distance between the teeth of the first body and the first rotational axis is advantageously different than the distance of the teeth of the second body from the first rotational axis. In particular, a diameter of a toothing system can have a pitch circle diameter in each case.

The first body and the second body can advantageously be motor shafts or carrier structures (housings). In particular it is advantageously possible for the carrier structure to be thought of as being a housing or a motor housing in which the first body and the second body are rotatably mounted or in which one of the bodies is rotatably mounted and the other is connected to the carrier structure or is part thereof, wherein the actuators can be connected to the carrier structure.

The rotary drive according to the invention also has a converter which has a first toothing system of the converter, which first toothing system runs around along a circular circumference at a first spacing about a second rotational axis, and a second toothing system of the converter, which second toothing system runs around coaxially with respect to the first toothing system along a circular circumference at a second spacing. The converter can also be synonymously referred to as a rolling body or simply as a third body. The converter can advantageously be, apart from the toothing system, a cylindrical or disk-shaped body.

According to the invention, the second rotational axis is arranged parallel to the first rotational axis and spaced apart therefrom. The axes preferably lie one next to the other.

The rotary drive according to the invention has at least two actuators with directions of action which are not parallel to one another and whose directions of action are therefore at an angle to one another which is unequal to 0° and unequal to 180°. However, if the rotary drive according to the invention has more than two actuators, it is therefore possible for some of these actuators to be at an angle of 0° or 180° with respect to one another.

The converter can be shifted in each case in one direction by means of the at least two actuators. The converter can thus advantageously just be shifted in precisely one direction by means of a given actuator of the actuators if the action of other actuators is ignored. In this sense, the actuators can also be considered to be linear actuators.

According to the invention the first toothing system of the converter is in engagement in a first engagement region with the toothing system of the first body, and the first toothing system of the converter is therefore meshed in the first engagement region with the toothing system of the first body. Furthermore, the second toothing system of the converter also engages in a second engagement region with the toothing system of the second body, that is to say meshes with this toothing system in the second engagement region.

The first engagement region and the second engagement region advantageously extend over only a portion of the circumference of the first toothing system of the converter and of the toothing system of the first body or of the second toothing system of the converter and the toothing system of the second body, that is to say not around its entire circumference.

According to the invention the converter can therefore be shifted in one direction in each case by means of the at least two actuators, in such a way that the second rotational axis runs around along a circular path about the first rotational axis.

Whether a rotational axis is mentioned in this document, it is to be understood firstly as meaning just a rotational axis in the mathematical sense. However, the corresponding converter or body can be mounted so as to rotate about the corresponding rotational axis and/or have a physical axle lying on the rotational axis.

The first distance at which the first toothing system of the converter runs around the second rotational axis is preferably unequal to the second distance at which the second toothing system of the converter runs around the second rotational axis.

In the rotary drive according to the invention, an internal toothing system or inner toothing system is advantageously engaged with an external toothing system or an outer toothing system. The toothing system of the first body can therefore be an internal toothing system, and the first toothing system of the converter can be an external toothing system, or the toothing system of the first body can be an external toothing system and the first toothing system of the converter can be an internal toothing system. It is also possible for the first toothing system of the second body to be an internal toothing system and the second toothing system of the converter to be an external toothing system or the toothing system of the second body to be an external toothing system and the second toothing system of the converter to be an internal toothing system.

The rotary drive according to the invention advantageously has a carrier structure which can particularly preferably be a housing. It is advantageously possible for the at least two actuators to be permanently connected to the carrier structure or the housing. Alternatively or else additionally, either the first or the second body can also be permanently connected to the carrier structure and/or be part of the carrier structure.

If the rotary drive according to the invention has a carrier structure or a housing as a carrier structure, only the at least two actuators as well as possible further actuators can also be permanently connected to the carrier structure and the first body and also the second body can be rotatable with respect to the actuators and the carrier structure. In this refinement, the rotary drive according to the invention can be particularly advantageously used as a phase shifter in which the first body and the second body rotate at the same speed about the first rotational axis, but in this context, in order to change the phase with respect to the first body, the first body can be moved forward or backward about the first rotational axis with the result that the rotational phase between the first body and the second body is changed.

In one advantageous refinement of the rotary drive according to the invention, in each case a shaft can be connected to the first body and/or to the second body or the first and/or the second bodies may each be part of a shaft.

The force applied by the actuators is advantageously directed in each case onto the actuator or away from it. It is possible in this context for the actuators therefore to be referred to as linear actuators since they advantageously apply a force only in one main direction. In this context, a main direction is understood to be a direction in which the forces applied by the corresponding actuator act on average. Even if superimposition of the actions of the various actuators results in forces which are not directed onto one of the actuators in this way, a linear actuator is to be understood here as one which applies a force in the direction of the actuator or away from the actuator when other influences are absent.

In one advantageous refinement, the rotary drive according to the invention can have at least one eccentric which can run around the first rotational axis and is arranged in such a way that it blocks a relative movement of the converter with respect to the first and/or second body in a radial direction with respect to the first rotational axis, by means of which relative movement the toothing system of the first and/or the second body would be disengaged from the corresponding toothing system of the converter. Such an eccentric can ensure particularly reliable operation even at high load torques. The eccentric advantageously has a contact region which runs around the outside and is in contact with a contact region of the converter which runs around the inside, at least in a region which is arranged radially in relation to the first rotational axis in the same direction or in the opposite direction to the first and/or the second engagement regions. Alternatively the eccentric can have a contact region which runs around the inside and is in contact with a contact region of the converter which runs around the outside, at least in a region which is arranged radially in relation to the first rotational axis in the same direction or in the opposite direction to the first and/or the second engagement regions.

In one advantageous refinement, the eccentric can be a plate, a ring or a cylinder which is preferably circular. In this context, the eccentric can be mounted so as to be rotatable about the first rotational axis. Its axis of symmetry can be offset with respect to the first rotational axis radially in relation to the first rotational axis in the direction of the first engagement region or away from the first engagement region and/or in the direction of the second engagement region or away from the second engagement region. The eccentric can therefore be mounted so as to be rotatable with its axis of symmetry offset in parallel about the first axis, and the axial offset can be directed, in relation to the first axis, in the direction of the first engagement region or away from the first engagement region and/or in the direction of the second engagement region or away from the second engagement region.

The rotary drive according to the invention can advantageously have at least one balancing mass which is arranged in such a way that its center of gravity is radially opposite a center of gravity of the converter in every position of the converter in relation to the first rotational axis or is radially in the same direction as the center of gravity of the converter. If the center of gravity lies in the same direction as the center of gravity of the converter, an imbalance is amplified, and if it lies in the opposite direction an imbalance is compensated.

In particular, a center of gravity of the eccentric can also lie radially opposite a center of gravity of the converter in every position of the converter relative to the first rotational axis or can lie in the same direction as the center of gravity of the converter.

The actuators advantageously each apply a force directly to the converter. They therefore advantageously generate a force which acts on the converter or on an actual axle of the converter.

In particular, a refinement wherein the actuators each apply a force to an axle lying on the second rotational axis or a rotary bearing of the converter which lies on the second rotational axis and on which the converter is rotatably mounted is also advantageous. The actuators can preferably be permanently connected to the axle or to the rotary bearing. In this context, they can be connected, in particular, by that end of the corresponding actuator on the axle or the rotary bearing to which they are not connected, for example, to a carrier structure or a housing.

In one advantageous refinement, the actuators can act by means of electro-magnetic forces. In this case, the converter and/or a rotary bearing of the converter preferably have/has a ferromagnetic material or is/are composed of such a material.

In one advantageous refinement of the invention, at least two toothing systems which engage one in the other can be cycloid toothing systems and/or evolvent toothing systems. It is therefore possible for the toothing system of the first body to form a cycloid toothing system and/or an evolvent toothing system with the first toothing system of the converter, and/or the toothing system of the second body can form a cycloid toothing system and/or an evolvent toothing system with the second toothing system of the converter.

Furthermore, a method for operating a rotary drive as described above is according to the invention. In this context, the actuators are actuated and/or energized to rotate in such a way that they apply or give rise to a force which rotates about the first rotational axis to the converter and/or a rotary bearing of the converter. In this context, in each case an attracting and/or repelling force can advantageously be applied by the actuators to the converter and/or the rotary bearing.

Various activation patterns of the actuators are possible. For example, at a given time in each case there can therefore be precisely one actuator active. However, it is also active for a plurality of actuators to be fully active or for a plurality of actuators to be active in a phase-offset fashion.

The actuators can advantageously be activated by energization. In one advantageous refinement it is possible to energize the actuators with a sinusoidal current profile, wherein adjacent actuators are energized with current from adjacent phases, and wherein a phase difference between two adjacent phases is equal to the angle between two adjacent actuators which the latter enclose with the rotational axis in a plane perpendicular to the rotational axis. A number of actuators which is greater than or equal to three is advantageously arranged here at equidistant angular intervals about the rotational axis.

According to the invention, with the rotary drive according to the invention a method for detection of load torques can also be carried out, wherein a torque is determined between the first body and a carrier structure and/or a second body and the carrier structure and/or between the first and the second body in that amplitudes and/or phase relationships between the electrical variables of the current, voltage and/or charge of the actuators are detected by means of electronic evaluation means and/or by evaluating electrical inductances, electrical capacitances and/or electrical resistances of the actuators.

A method for detecting the position and/or attitude of a rotary drive as described above is also according to the invention, wherein the position and/or the attitude of the converter is detected with respect to a carrier structure and/or of the first body and/or of the second body with respect to the carrier structure and/or of the bodies with respect to one another by evaluating the amplitudes and/or phase relationships between the electrical variables of the current, voltage and/or charge of the actuators by means of electronic evaluation means and/or by evaluating electrical inductances, electrical capacitances and/or electrical resistances of the actuators.

In order to detect the rotational speed and/or position and/or forces between the first body and a carrier structure and/or a second body and the carrier structure and/or between the first and the second bodies there may advantageously be sensors present.

In one advantageous refinement, the rotary drive can have the following features:
a rotatably mounted motor shaft with a toothing system,
an annular, cylindrical or disk-shaped element which is referred to as a converter and has a first and a second toothing system, wherein the converter can be rolled with its second toothing system in the toothing system of the motor shaft,
a motor housing having a toothing system, wherein the first toothing system of the converter can be rolled in the toothing system of the motor housing,
electrically controllable actuators by means of which forces which rotate with respect to the motor shaft axis can be applied to the converter,
with the result that the converter can be excited by the electrically controllable actuators to perform a circular shifting movement in the plane perpendicular to the motor shaft axis such that the converter rolls with its first toothing system in a positively engaging fashion in the toothing system of the motor housing, and at the same time the converter rolls with its second toothing system in the toothing system of the motor shaft in a positively locking fashion and the motor shaft is made to rotate.

The present invention provides a rotary drive which is distinguished by a high torque density, a high positioning accuracy and cost-effective manufacture. This can advantageously be achieved, in particular, by the measures described below.

In one advantageous refinement, the converter can form, with its first and second toothing systems, a two-stage transmission through interaction with the toothing systems of the motor housing and of the motor shaft.

The first transmission stage can be formed by the toothing pairing of the first toothing system of the converter and the toothing system of the motor housing.

The second transmission stage can be formed by the toothing pairing of the second toothing system of the converter and the toothing system of the motor shaft.

Each transmission stage can have a separate transmission ratio which is provided by the difference in the number of teeth of the tooth pairings which roll one in the other in a positively engaging fashion.

The motor shaft, converter and motor housing preferably have circular toothing systems.

The toothing systems of the motor shaft and motor housing are preferably arranged concentrically with respect to one another on one axis. Toothing systems arranged concentrically with respect to one another is advantageously understood to mean that the toothing systems are arranged coaxially with respect to an axis, and the pitch circle center points of the toothing systems lie on this axis.

The converter can advantageously be excited by electrically controllable actuators to perform movements preferably in the plane which lies perpendicular to the axis of the motor shaft. Actuators which can be controlled electrically is preferably understood to mean actuators which convert electrical energy into mechanical energy and which can apply attracting or repelling and/or attracting and repelling forces to bodies.

In particular, the actuators are preferably linearly acting actuators and not rotational actuators such as, for example, eccentrics or electric motors.

In particular, magnetic forces which act by means of electro-magnetic actuators, preferably in the plane perpendicular to the axis of the motor shaft and magnetic forces which run around the axis of the motor shaft can advantageously be applied to the converter. All the designs of presently known electromagnets are suitable as electro-magnetic actuators. Electro-static actuators can also be used as actuators. Solid-state actuators can likewise be used as actuators before shifting the converter. In one preferred embodiment, the actuators can be electromagnets which can be actuated electrically and are arranged radially with respect to the axis of the motor shaft.

The electromagnets can, for example, each have a core of ferromagnetic material around which a coil composed of turns of an electrically conductive insulated wire is wound. The cores of the electromagnets can advantageously be embodied as pole shoes. The arrangement of all the electromagnets with the cores and pole shoes can be referred to as a stator, and the individual electromagnets can be referred to as electrically controllable stator means. In one embodiment of the invention, the stator with the electrically controllable stator means can be permanently connected to a motor housing.

In particular, solid-state actuators or electro-static actuators, for example piezo-electric actuators, electro-strictive actuators, magneto-strictive actuators, magnetic shape memory MSM actuators, bimetal actuators, dielectric actuators, electro-static comb actuators, can also be advantageously used as electrically controllable stator means. In this case, the arrangement of these actuators which serve for circular shifting of the converter can be referred to as a stator, and the actuators as electrically switchable stator means.

The rotary drive according to the invention can advantageously be constructed in a plurality of designs, a number of which are described below:
Rotary drive with internal stator which is surrounded by the converter,
Rotary drive with external stator in the interior of which the converter is arranged,
Rotary drive having a converter which is surrounded by an internal and an external stator, and
Rotary drive having a plurality of stators, corresponding to the combination of the three arrangements above.

In particular, the converter can advantageously be annular, cylindrical, circular or disk-shaped.

If the stator means are electro-static actuators with two spaced-apart electrode arrangements or are composed thereof, between which electrode arrangements controllable forces can be generated by applying a variable electrical potential difference, it is possible in each case to connect one of the electrode arrangements to the converter and/or the rotary bearing of the converter and the other to the motor housing.

The converter and/or the rotary bearing of the converter can in this case have any desired material or be composed of any desired material, for example silicon, plastic, metal.

If the stator means are other non-electro-magnetic actuators, for example piezo-actuators, they are advantageously connected as rigidly as possible by one of their ends in the direction of action of the respective actuator and as softly as possible in the direction perpendicular to the direction of action of the respective actuator, to the converter and/or to the rotary bearing of the converter, and connected by their other end to the motor housing with the result that the actions of a plurality of actuators which are attached to the converter and/or the rotary bearing of the converter can be superimposed with as little interference as possible. In this context, the converter and/or the rotary bearing of the converter can also have any desired material or be composed thereof, for example silicon, plastic, metal.

In order to explain the design and the function of the rotary drive according to the invention, reference is firstly made to electro-magnetic stator means, i.e. electromagnets, for reasons of clarity of the illustration. In this context, at least in certain parts the converter has or is composed of a ferromagnetic material on which the stator means (electromagnets) can apply electro-magnetic forces.

In the case of an internal stator, the pole shoes of the stator can be surrounded at a short distance by the soft-magnetic converter. Soft-magnetic materials are understood here to be ferromagnetic materials. The distance is preferably selected to be as small as possible, with the result that the magnetic forces acting on the converter become a maximum but mechanical contact between the poles of the stator and the converter is ruled out. It is not necessary for the entire converter to be composed of soft-magnetic material. For the function of the rotary drive it is sufficient if the converter has at least partially soft-magnetic material in the areas opposite the pole shoes or is composed of said material in these certain parts. In a further embodiment, the converter can have permanent magnets on its surface facing the pole shoes.

The design of the rotary drive with an external stator can be structured analogously, with the exception that the converter is internal and is surrounded by the pole shoes of the stator at a short distance.

In order to increase the power further, the converter can advantageously be enclosed by an internal stator and an external stator between which there is an annular gap in which the ring-shaped or bell-shaped converter is arranged.

It is also possible for the rotary drive to have a plurality of stators which can transmit forces to the converter, wherein the stators can be both internal and/or external.

In particular, the pole shoes of the stator are preferably arranged concentrically with respect to the toothing systems of the motor shaft and motor housing. The center points of the motor shaft toothing system, motor housing toothing system and stator are preferably located on one axis. Both the toothing systems and the stator advantageously each lie in planes which are oriented perpendicularly with respect to this axis. The longitudinal extent of these elements along the axis is not limited.

In contrast to all the known designs of electric motors, in the drive according to the invention radially acting magnetic forces can advantageously be predominantly applied to the converter by rotating phase-offset energization of the electromagnets or magnetic poles of the stators.

The rotating magnetic forces which act, in particular, radially on the converter can advantageously lead to a positively engaging engagement and rolling of the toothing systems of the converter in the toothing system of the motor shaft housing and at the same time of the toothing system of the motor shaft and therefore to rotation of the motor shaft.

For this purpose, the pairings of the motor shaft toothing system/second toothing system of the converter and motor housing toothing system/first toothing system of the converter are preferably embodied in such a way that they have the same eccentricity. However, small differences in the eccentricity do not adversely affect the function of the rotary drive. In particular, the axle offset of the center point of the pitch circle of the one toothing system with respect to the center point of the pitch circle of the other toothing system can be understood as eccentricity of a toothing system pairing.

In the axial direction, i.e. in the direction of the motor shaft axis, the shifting of the converter can advantageously be limited by stops, shim rings/spring washers or other elements or devices.

In the radial direction, the maximum shifting of the converter is preferably limited by the diameter differences of the motor shaft toothing system with respect to the second toothing system of the converter and of the motor housing toothing system with respect to the first toothing system of the converter. In particular, these two toothing system pairings advantageously have as far as possible the same eccentricity.

By means of further mechanical means (not illustrated) it is additionally advantageously possible to assist parallel guidance of the converter in the plane perpendicular to the axis of the motor shaft, without impeding the shifting and rotation of said converter. For this purpose, the converter can, for example, be suitably fitted with its boundary faces into the motor housing and the further motor components, or provided with additional guide faces, for example side disks or bearing means such as ball bearings, needle bearings, sliding bearings.

In order to drive the rotary drive it is advantageously possible to move the toothings systems of the converter into engagement with the motor shaft toothing system and the motor housing toothing system. For this purpose, the magnetic poles of the stator can be energized in such a way that a radial sum force is applied to the converter by the magnetic poles. As a result, an initial setting of the motor shaft can be defined and the motor shaft can initially be held in its rotational angle position.

Starting from this phase angle, the electrical energization pattern of the magnetic poles can then be rotated circumferentially with respect to the axis I-I′ of the motor shaft. Different energization patterns are suitable for the rotary drive. For example, in each case just one magnetic pole can be energized and the energization can be switched from one magnetic pole to the other. This results in a more step-like rotation of the motor shaft. More uniform rotation of the motor shaft can be achieved, for example, by rotating, phase-offset energization of, in each case, a plurality of magnetic poles, wherein the signal shape of the electrical currents of the magnetic poles is preferably sinusoidal. The rotating signal shape of the energization of the individual magnetic poles for applying a rotating radial force to the converter can, however, be of very different type. For example, the magnetic poles can also be energized in a rotating fashion with triangular, ramp-shaped, trapezoidal, saw-tooth-shaped or other signal shapes with different phase offsets between the individual magnetic poles. In particular, the reluctance principle is also suitable for the rotary drive according to the invention.

The rotary drive according to the invention can have a multiplicity of magnetic poles. For example, the following functionality can then be implemented. The magnetic poles are numbered continuously from P1 to PX for the illustration. Without restriction of generality and only for the purpose of illustration it is assumed that the rotary drive has a number of PX magnetic poles and firstly only the magnetic pole P1 is fully energized, while all the other magnetic poles are non-energized. It is assumed below that the converter has soft-magnetic material or is composed thereof. The energization of magnetic pole P1 gives rise to an attraction force which is directed radially onto the converter by the magnetic pole P1, as a result of which the toothing systems of the converter move into complete engagement with the toothing systems of the motor shaft and the motor housing. As a result of energization of the adjacent magnetic pole P2 and de-energization of magnetic pole P1, an attraction force directed onto the magnetic pole P2 then acts on the converter, as a result of which the converter rolls with its first toothing system in the motor housing toothing system until the distance between the converter surface and the magnetic pole P2 is minimal and a new force equilibrium has become established. As a result of repeated sequential advancing of the energization from magnetic pole P1 to magnetic pole PX, the converter can consequently roll with its first toothing system in the motor housing toothing system and is as a result made to rotate. As a consequence of the different diameters of the first toothing system of the converter and of the motor housing toothing system and the eccentricity which is caused as a result, a circular shifting movement (=tumbling movement) of the converter is superimposed on the converter's intrinsic rotation here. Owing to the tumbling movement of the converter, the toothing system of the rotatably mounted motor shaft therefore simultaneously rolls in the second toothing system of the converter, as a result of which the motor shaft is made to rotate with respect to the converter. In addition, the converter's intrinsic rotation is transmitted to the motor shaft with the ratio of the number of teeth of the motor shaft external toothing system to the number of teeth of the second internal toothing system of the converter. The resulting rotation of the motor shaft with respect to the motor housing results from the addition of these components. Therefore, while the first transmission stage of the converter converts the radially rotating magnetic forces into a tumbling movement of the converter with a superimposed rotational movement of the converter, the second transmission stage of the converter converts the tumbling movement back into a pure rotation of the motor shaft, on which the rotational movement of the second transmission stage is additionally superimposed.

The rotary drive according to the invention can therefore advantageously convert radially rotating active forces, in particular electromagnetic traction forces and compressive forces into rotation. Through the possibilities of different toothing system configurations and the combination thereof, a very large spread of the transmission ratio is possible, from an extreme step-up to a step-down. The rotary drive according to the invention requires only a small number of components and is of extremely compact design. In particular, it does not necessarily require a mechanical bearing for the converter, for example in the form of an eccentric connecting rod, but such a rod can optionally be provided. The converter and the rolling kinematics of the toothing systems therefore convert shifting movements particularly efficiently into rotation and torque. In conjunction with cycloidal toothing systems a high overload capability is provided, but the rotary drive can also have evolvent toothing systems or other forms of toothing system. In particular, the rotary drive according to the invention is suitable for controlled operation since there is a clear assignment between the mechanical angular position of the motor shaft and the electrical phase.

The following further embodiments of the rotary drive according to the invention are also possible.

The converter can roll in a contact-making fashion on the pole shoes. The force-type engagement can be both a friction engagement as well as a positive engagement here. For this purpose, the pole shoes and the regions between the pole shoes can have a closed or partial toothing system (toothing system of the first body) in which the first toothing system of the converter rolls.

The converter which rolls eccentrically in its toothing systems can be arranged in such a way that it moves close to the pole shoes in the motor mode only up to a minimum distance, without making contact therewith. This distance can be ensured by the toothing systems and/or by an eccentric.

Likewise, the rotary drive can have a plurality of stators and/or converters which are interleaved one in the other and/or arranged along an axle, wherein the stators can be both internal and/or external. The converter can also have more than a first toothing system and/or more than a second toothing system which roll in corresponding toothing systems of the shaft and housing.

For the function of the rotary drive it is sufficient if the converter in the regions adjoining the pole shoes has at least partially ferromagnetic material. In a further embodiment, the converter can have permanent magnets, with the result that the actuators can apply tractive and/or compressive forces thereto.

In particular, the pole shoes of the stator can be arranged coaxially with respect to the toothing systems of a shaft or shafts and a housing or housings. The center points of the pitch circles on a shaft toothing system or shaft toothing systems and a housing toothing system or housing toothing systems can advantageously be located on an axis of the stator which constitutes a rotational axis with respect to the shaft or shafts. In particular, the toothing systems and the stator with the magnetic poles lie in planes which are oriented perpendicularly with respect to the rotational axis. The longitudinal extent of these elements along the rotational axis is not limited.

In contrast to known electric motors, the rotary drive according to the invention has a rolling body or converter instead of a rotor. Advantageously, neither the magnetic fields of the energized electromagnets of the stator nor solid-state actuators directly transmit torques to the converter in terms of rotations about the axis of symmetry of its coaxial toothing systems, i.e. its rolling axis. Instead, the converter is advantageously shifted by the approximately linearly acting actuators in a plane lying perpendicular with respect to the rotational axis.

According to the invention, the converter has toothing systems whose engagement regions are displaced when the actuators are continuously energized, with the result that the converter rolls in assigned toothing systems of shafts and/or housings and in the process carries out eccentric movements. The distance between the converter and the pole shoes is therefore variable during the eccentric movement of the converter. In the case of electric motors of a customary design, the rotor is mounted spaced apart concentrically from the pole shoes and carries out a purely rotational movement, and does not carry out an eccentric movement. Accordingly, the distance between the rotor and the pole shoes is constant in the case of conventional electric motors. The generation of torque in the case of the rotary drive according to the invention is based on the fact that the converter is shifted eccentrically with respect to the load-free state when external load torques act if individual magnetic poles or actuators, or a plurality thereof, are energized, as a result of which restoring force components acting on the converter are generated, said force components becoming active as torques between the first body (housing or shaft) and the second body (housing or shaft).

The toothing systems of the at least one shaft, the housing and the converter are advantageously embodied in such a way that they can roll in such a way that they mesh with one another.

A mechanical bearing of the converter, for example in the form of an eccentric, can be present but is not functionally necessary.

The converter can be at least partially annular, cylindrical, circular or disk-shaped and can have different diameters in its longitudinal extent.

The converter can advantageously have a plurality of functionally optimized areas and/or be composed of such areas.

Materials which are filled with ferromagnetic particles, in particular plastics which can be easily and cost-effectively processed, for example, by injection molding, are also advantageously suitable for the rotary drive.

The converter can have, at least partially, permanent magnets and/or other ferromagnetic or non-ferromagnetic materials or be composed of such materials.

All types of electrical and non-electrical actuators, in particular linear actuators, are suitable as drive actuators for the converter.

In particular, the rotary drive can also be constructed with a combination of different actuators. For example, a rotary drive can have electro-magnetic actuators and piezo-electric actuators.

Self-guiding toothing systems, which do not disengage under load, or only with difficulty, are also advantageously suitable for the rotary drive.

The toothing systems can advantageously be evolvent toothing systems or cycloidal toothing systems.

The rotary drives according to the invention can advantageously also have non-ferromagnetic materials. This results in a particular suitability for the operation thereof in magnetic fields. Rotary drives with actuators other than electro-magnetic actuators additionally have only small electro-magnetic leakage fields (EMC).

All the designs of electro-magnetic rotary drive variants can also be constructed by means of solid-state actuators or other actuators.

If actuators, in particular solid-state actuators, are connected to the drive ring, wherein the converter is rotatably mounted in the drive ring, additional electro-magnetic actuators may be present which also apply forces to the drive ring and/or to the converter.

The actuators can also be mechanically coupled to a drive ring or apply forces thereto in that the converter rolls in an eccentrically rotating frictionally-engaging or positively-engaging fashion when the drive ring moves in a cyclically circular fashion.

Solid-state actuators are preferably attached in a rigid fashion, in their main direction of action, between the drive ring and the housing, but are sufficiently flexible in the perpendicular direction with respect to the latter so that the deflections and forces of a plurality of actuators acting on the drive ring can be superimposed without destruction. In order to mechanically decouple various directions of action, kinematics, which can be mounted between the actuators and the housing and/or the actuators and the rotary bearing of the converter and/or the actuators and the drive ring are known from the prior art. Examples of such kinematics are struts, which are resistant to compression with respect to one axis but in the perpendicular direction with respect thereto are resilient, as well as parallel structures, connecting links and rod kinematics.

If the converter 3 is rotatably mounted in the drive ring 4, only shifting movements of the drive ring 4 are transmitted to the converter 3, but rotational movements of the drive ring 4 about the rotational axis 1-1′ are not. The number of actuators of a stator ring and the number of stator rings are not limited.

When actuators other than electro-magnetic ones are used the converter and/or the drive ring can also have non-ferromagnetic material or can be composed of such a material, for example silicon, plastic, metal, alloys, composite materials.

In the following exemplary embodiments, the rotary drive according to the invention is described in more detail with reference to a number of figures and the function is explained in detail. Identical reference numbers correspond here to identical or corresponding features. The features which are shown in the examples can also be implemented independently of the specific example.

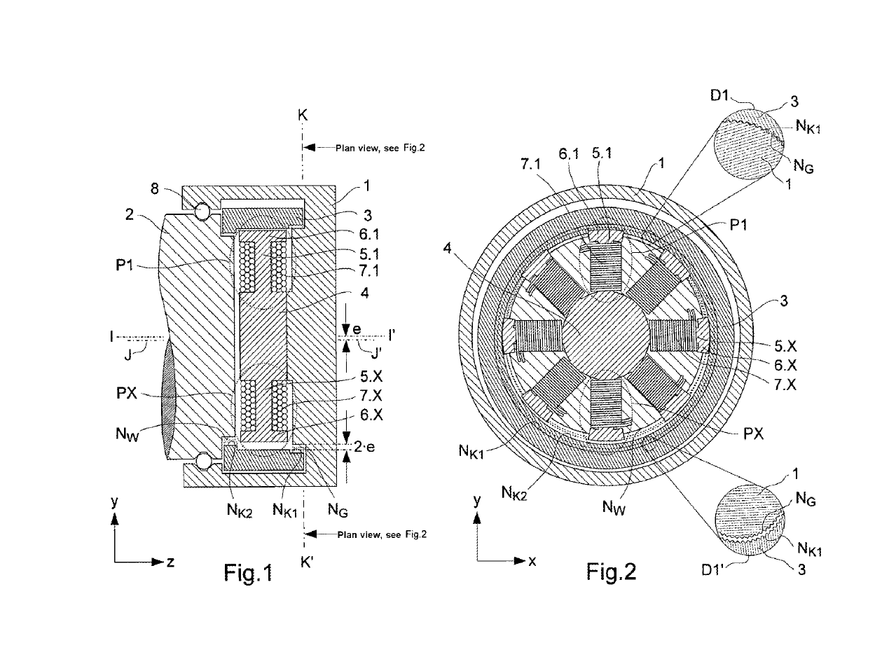

FIG. 1 shows, as a sectional drawing in a plan view, a rotary drive with an internal stator, a motor shaft with an external toothing system, a motor housing with an external toothing system which has a relatively large diameter compared to the external toothing system of the motor shaft, and an annular converter with two internal toothing systems corresponding to the external toothing systems of the motor shaft and motor housing,

FIG. 2 shows a section through the rotary drive illustrated in FIG. 1 along the line K-K′ in FIG. 1 in a plan view with an internal stator and an annular converter,

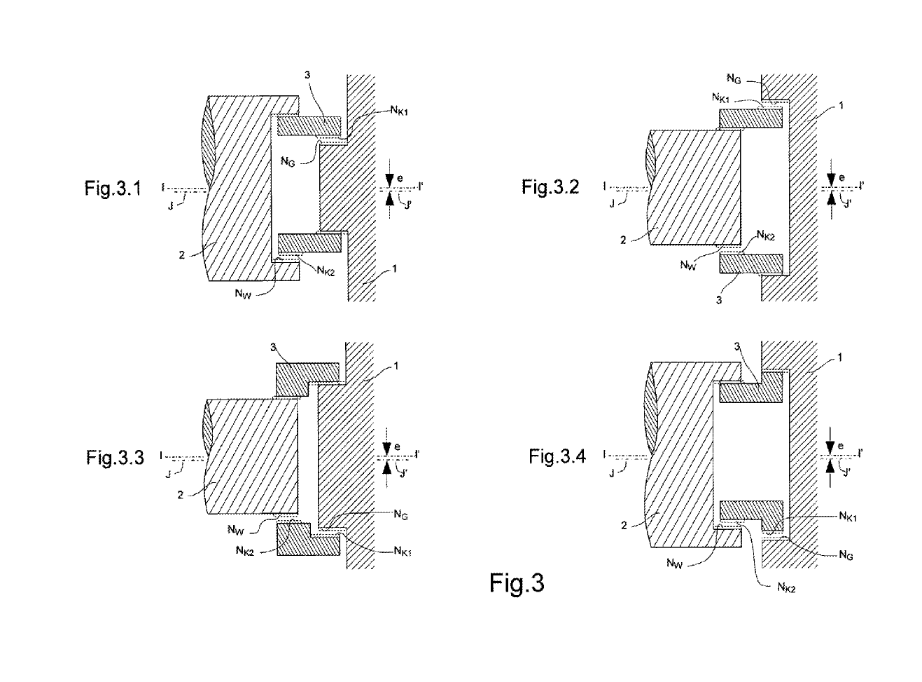

FIG. 3 shows four different basic shapes of the rotary drive according to the invention, which can be constructed by different arrangement of the three basic elements of the motor shaft, motor housing and converter,

FIG. 3.1 shows a rotary drive with an internal toothing system of the motor shaft and an external toothing system of the motor housing and an annular converter with two toothing systems,

FIG. 3.2 shows a rotary drive with an external toothing system of the motor shaft and an internal toothing system of the motor housing as well as an annular converter with two toothing systems,

FIG. 3.3 shows a rotary drive with an external toothing system of the motor shaft and an external toothing system of the motor housing, and an annular converter with two toothing systems,

FIG. 3.4 shows a rotary drive with an internal toothing system of the motor shaft and an internal toothing system of the motor housing as well as an annular converter with two toothing systems,

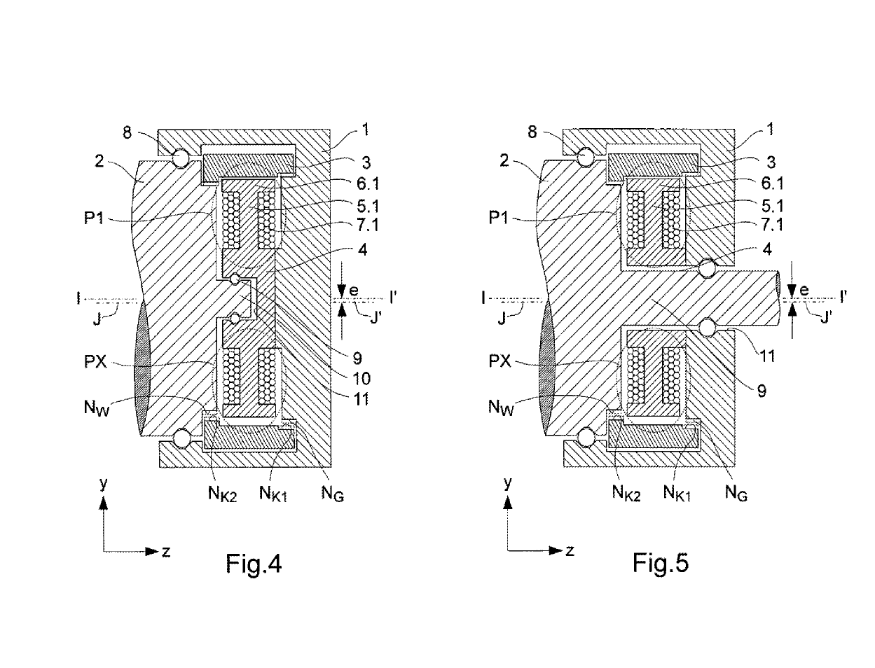

FIG. 4 shows a rotary drive in which the motor shaft is additionally mounted at the end side, a motor shaft with an external toothing system and an external toothing system of the motor housing which is larger in diameter, as well as an internal stator and an annular converter,

FIG. 5 shows a rotary drive in which the motor shaft is led out of the motor housing on both sides, a motor shaft with an external toothing system and an external toothing system of the motor housing which is larger in diameter as well as an internal stator and an annular converter,

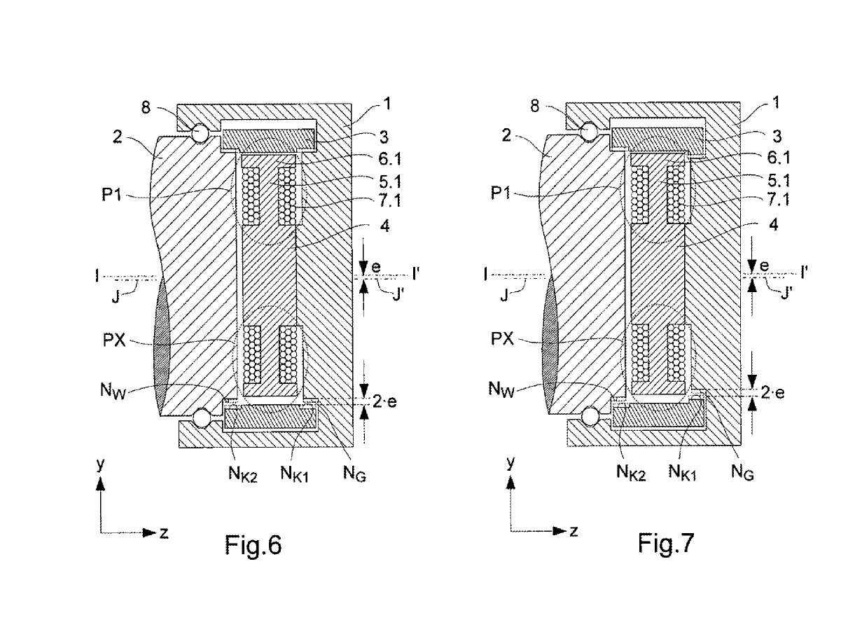

FIG. 6 shows a rotary drive with external toothing systems of the motor shaft and motor housing with the same diameter as well as an internal stator and an annular converter,

FIG. 7 shows a rotary drive, having an external toothing system of the motor shaft and an external toothing system of the motor housing which is smaller in diameter as well as an internal stator and an annular converter,

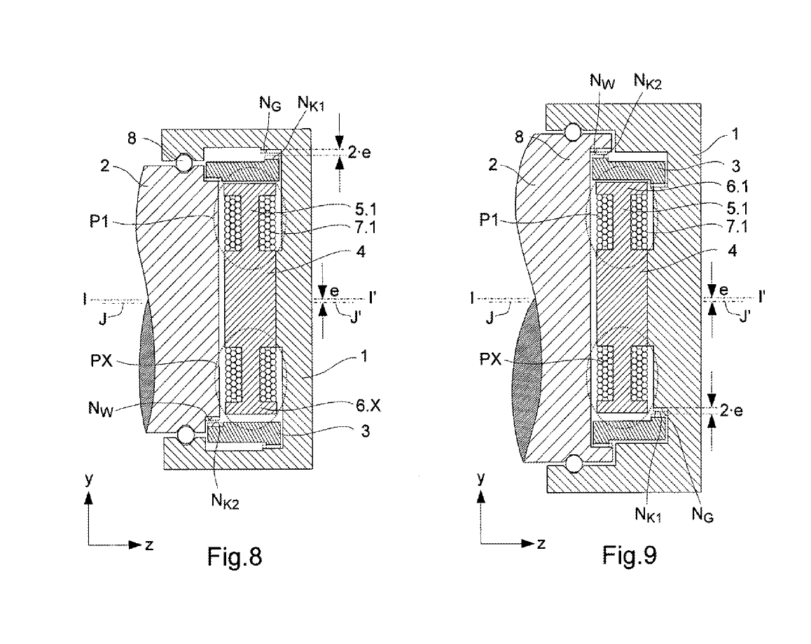

FIG. 8 shows a rotary drive, having an external toothing system of the motor shaft and an internal toothing system of the motor housing which is larger in diameter as well as an internal stator and an annular converter,

FIG. 9 shows a rotary drive, having an internal toothing system of the motor shaft and an external toothing system of the motor housing which is smaller in diameter as well as an internal stator and an annular converter,

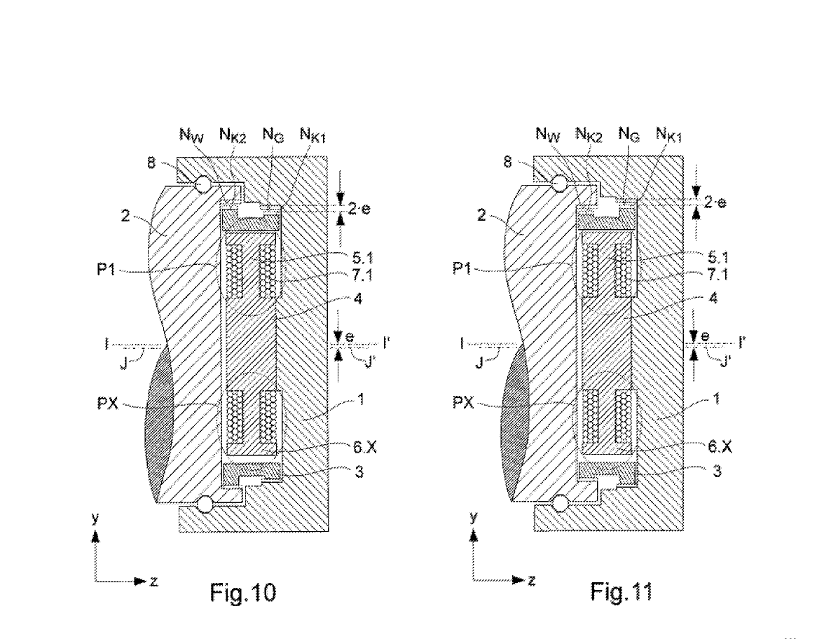

FIG. 10 shows a rotary drive, having an internal toothing system of the motor shaft and an internal toothing system of the motor housing which is smaller in diameter as well as an internal stator and an annular converter,

FIG. 11 shows a rotary drive having an internal toothing system of the motor shaft and an internal toothing system of the motor housing which is larger in diameter as well as an internal stator and an annular converter,

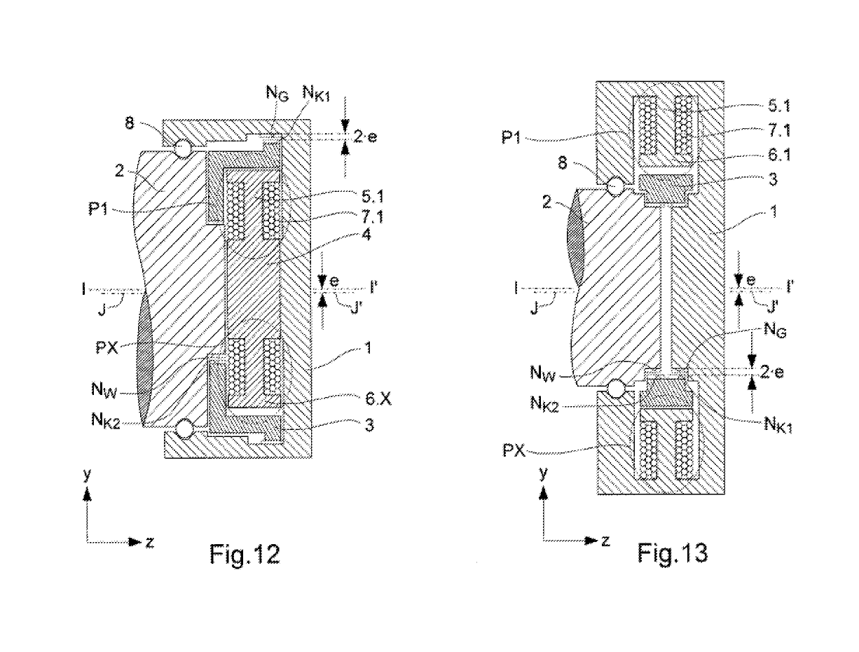

FIG. 12 shows a rotary drive, having an external toothing system of the motor shaft and an internal toothing system of the motor housing which is substantially larger in diameter as well as an internal stator and an annular converter,

FIG. 13 shows a rotary drive, having external toothing systems of a motor shaft and motor housing with the same diameter as well as an external stator and an annular converter,

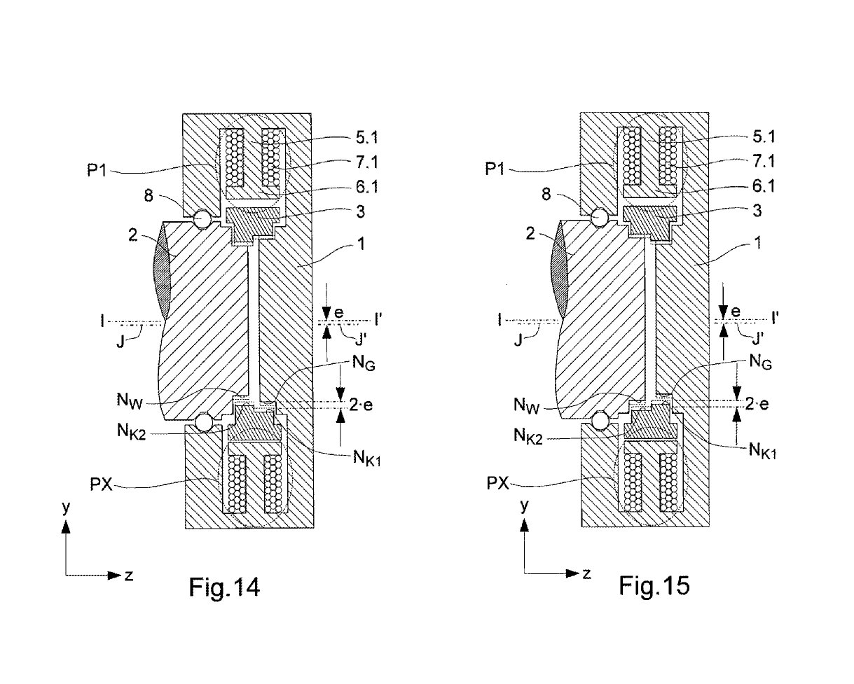

FIG. 14 shows a rotary drive, having an external toothing system of the motor shaft and an external toothing system of the motor housing which is larger in diameter as well as an external stator and an annular converter,

FIG. 15 shows a rotary drive having an external toothing system of the motor shaft and an external toothing system of the motor housing which is smaller in diameter as well as an external stator and an annular converter,

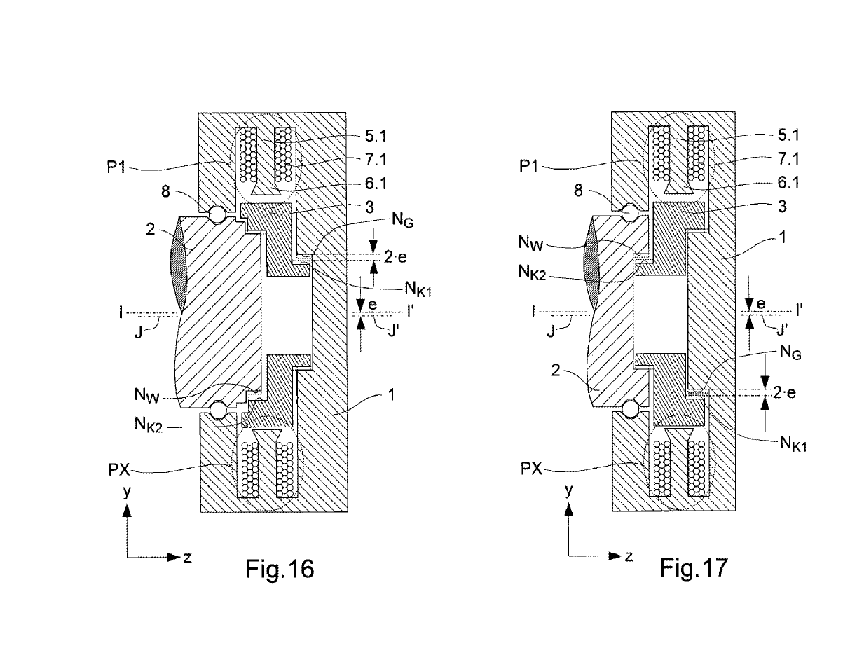

FIG. 16 shows a rotary drive, having an external toothing system of the motor shaft and an internal toothing system of the motor housing which is substantially smaller in diameter, as well as an external stator and an annular converter,

FIG. 17 shows a rotary drive, having an internal toothing system of the motor shaft and an external toothing system of the motor housing which is substantially larger in diameter as well as an external stator and an annular converter,

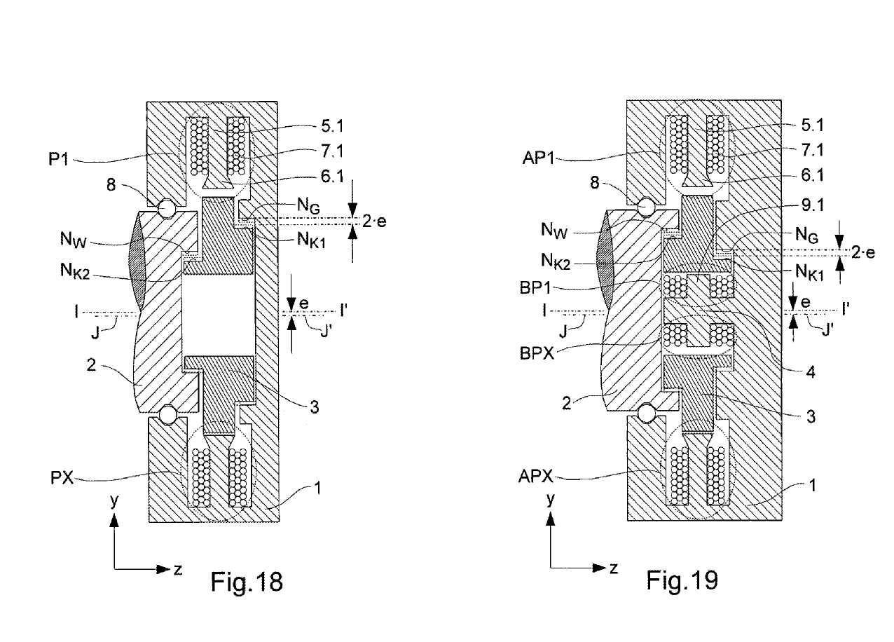

FIG. 18 shows a rotary drive, having an internal toothing system of the motor shaft and an internal toothing system of the motor housing which is substantially larger in diameter as well as an external stator and an annular converter,

FIG. 19 shows a rotary drive, having an internal toothing system of the motor shaft and an internal toothing system of the motor housing which is substantially smaller in diameter as well as an annular converter with external and internal stators,

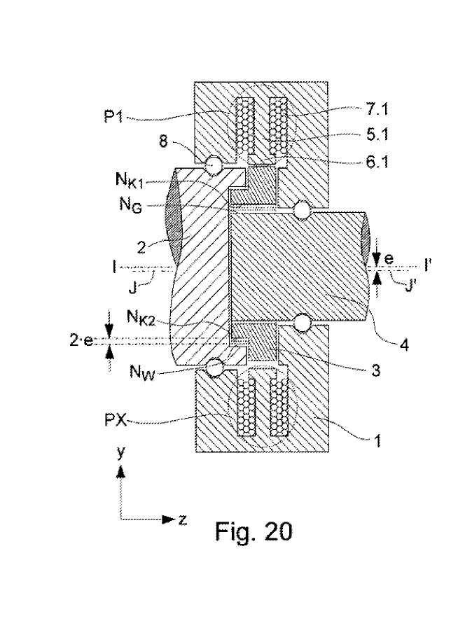

FIG. 20 shows a rotary drive having two motor shafts which are driven by the annular converter in a coupled fashion, wherein the first motor shaft has an internal toothing system and the second motor shaft has an external toothing system which is smaller in diameter as well as an external stator,

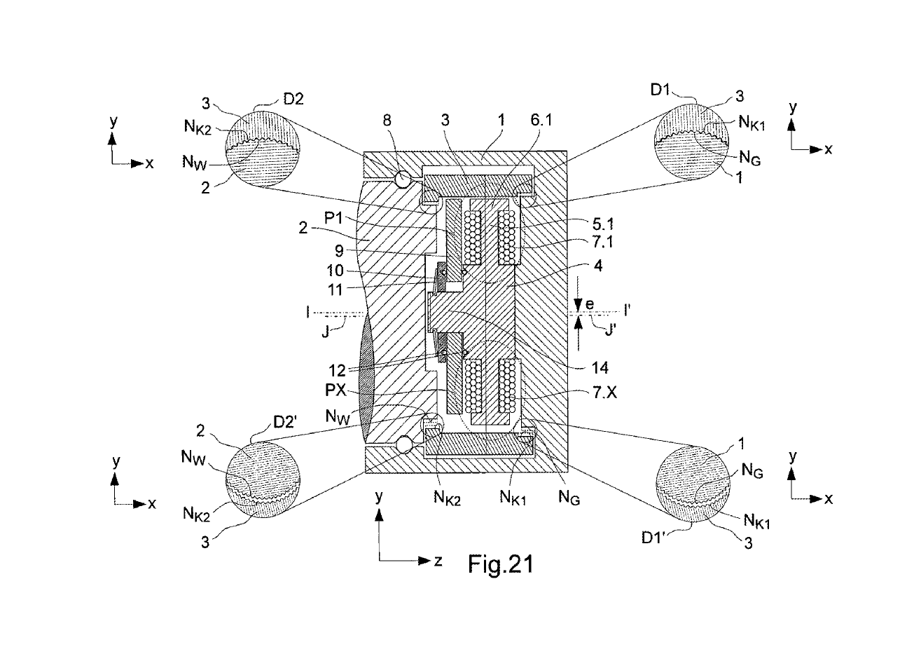

FIG. 21 shows a rotary drive having a disk-shaped mass balancing element and an external toothing system of the motor shaft and an external toothing system of the motor housing which is larger in diameter as well as an annular converter with an internal stator,

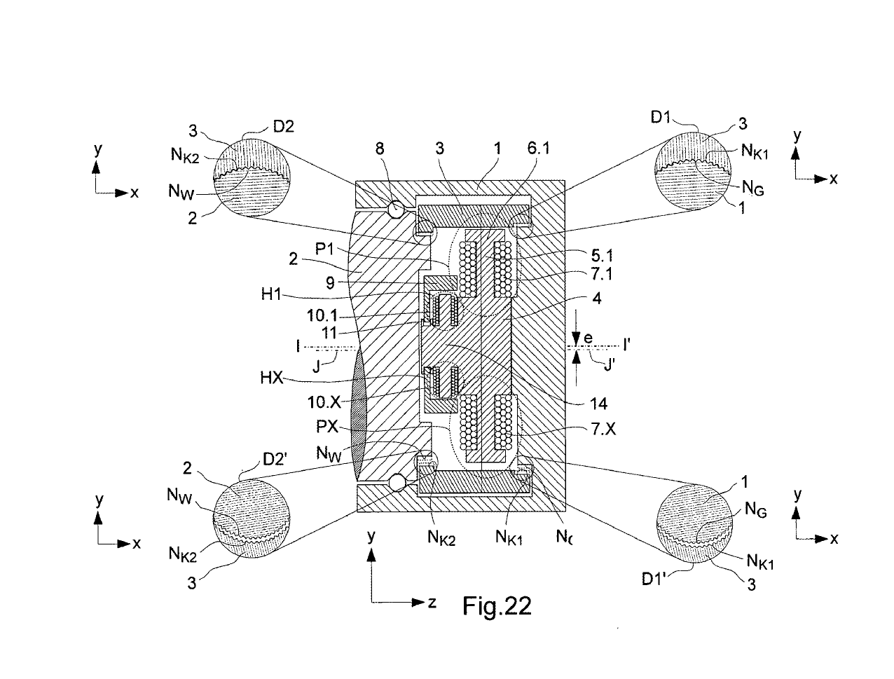

FIG. 22 shows a rotary drive of the inventive type, in which the mass balancing element is driven by means of separate auxiliary stator windings,

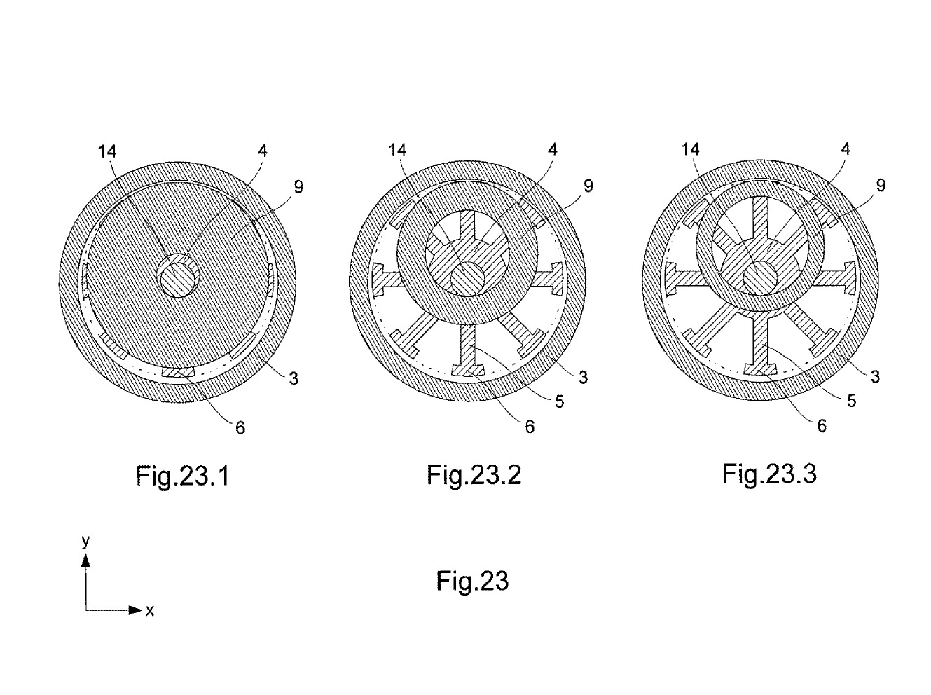

FIG. 23 shows various configuration possibilities of the disk-shaped mass balancing element for compensating motor imbalances,

FIG. 23.1 shows a rotary drive in a plan view with a first embodiment of a disk-shaped mass balancing element,

FIG. 23.2 shows a rotary drive in a plan view with a second embodiment of a disk-shaped mass balancing element,

FIG. 23.3 shows a rotary drive in a plan view with a third embodiment of a disk-shaped mass balancing element,

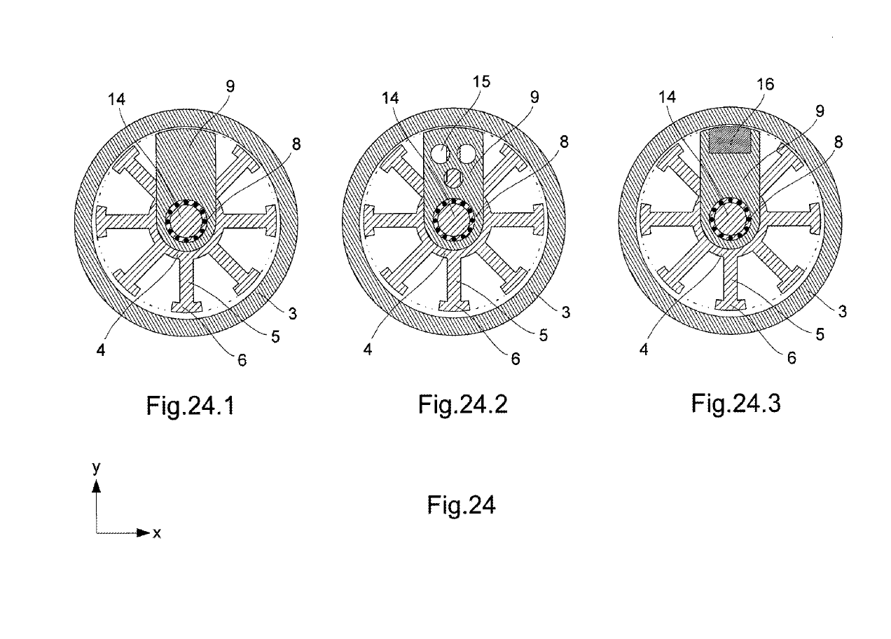

FIG. 24 shows different variants of a non-rotationally symmetrical mass balancing element for compensating motor imbalances,

FIG. 24.1 shows in plan view a soild embodiment of a non-rotationally symmetrical mass balancing element,

FIG. 24.2 shows in plan view an embodiment with cutouts of a non-rotationally symmetrical mass balancing element,

FIG. 24.3 shows in plan view an embodiment of a non-rotationally symmetrical mass balancing element with an additional weight or ferromagnetic material,

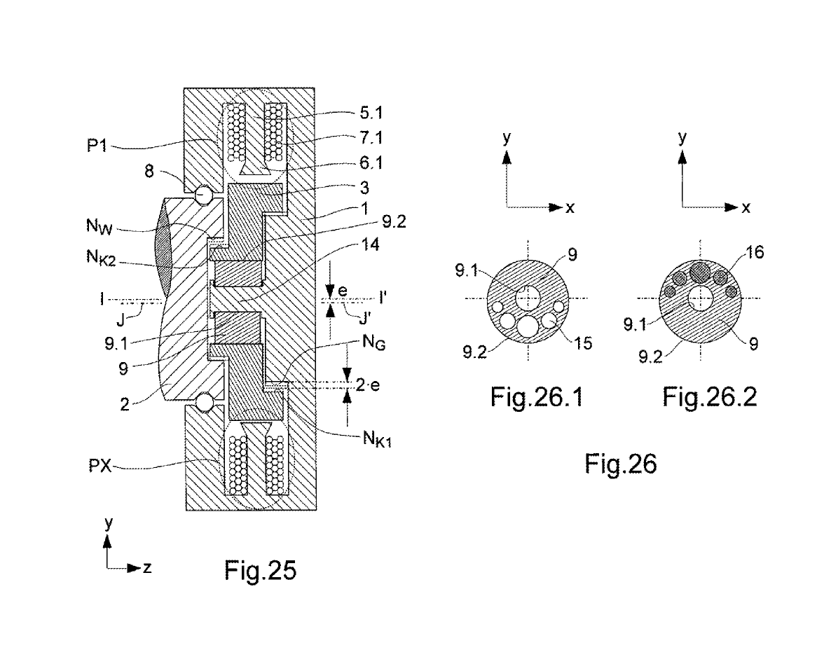

FIG. 25 shows a rotary drive in which the converter is mounted by means of an eccentric,

FIG. 26 shows two embodiment variants of eccentrics for compensating motor imbalances,

FIG. 26.1 shows an eccentric with cutouts for a rotary drive according to FIG. 25,

FIG. 26.2 shows an eccentric with additional weights for a rotary drive according to FIG. 25,

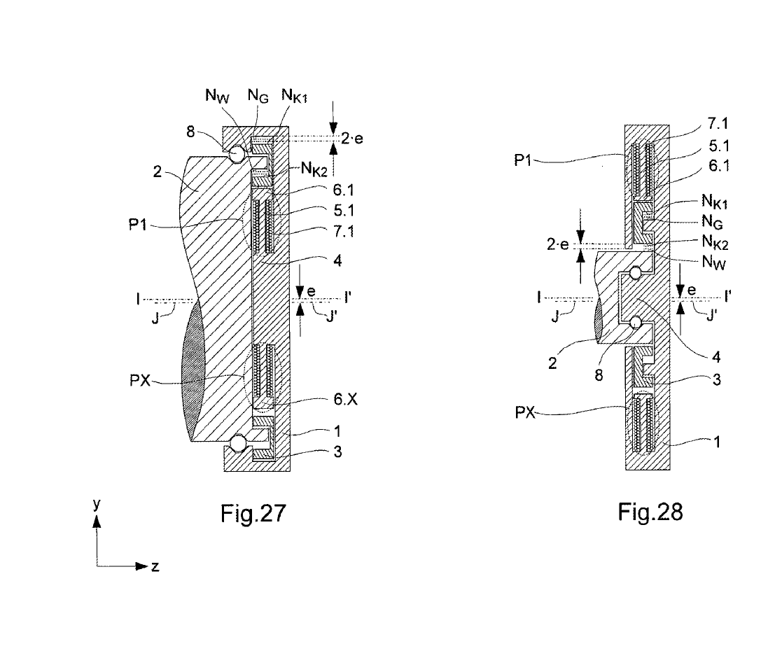

FIG. 27 shows a flat design of the rotary drive with an internal stator and U-shaped converter,

FIG. 28 shows a flat design of the rotary drive with an external stator and U-shaped converter,

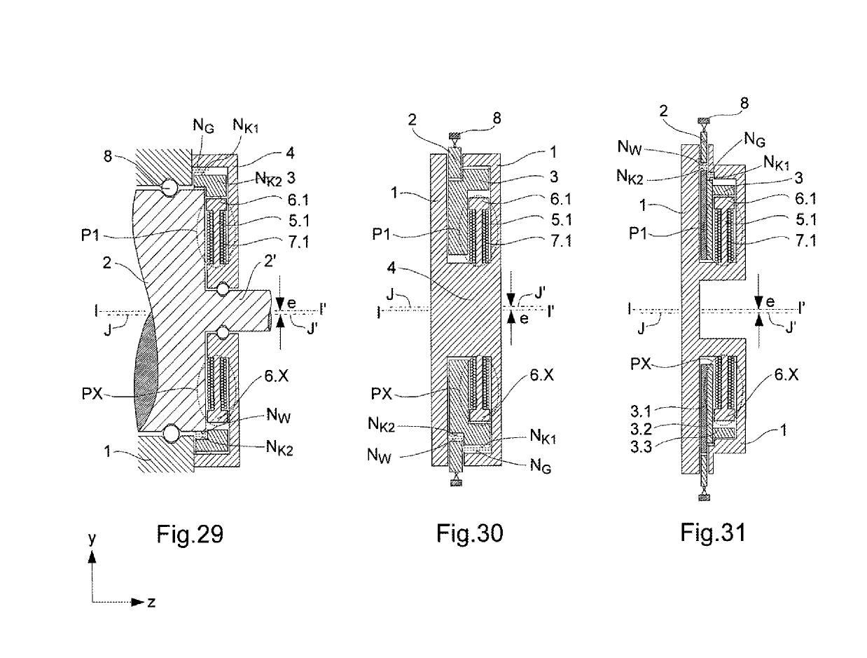

FIG. 29 shows a flat design of the rotary drive with a motor shaft which is led out on both sides and an internal stator,

FIG. 30 shows a flat design of the rotary drive with an internal stator in which the output element is an external ring,

FIG. 31 shows a rotary drive according to FIG. 30 in which the converter has a plurality of disk-shaped and/or annular elements,

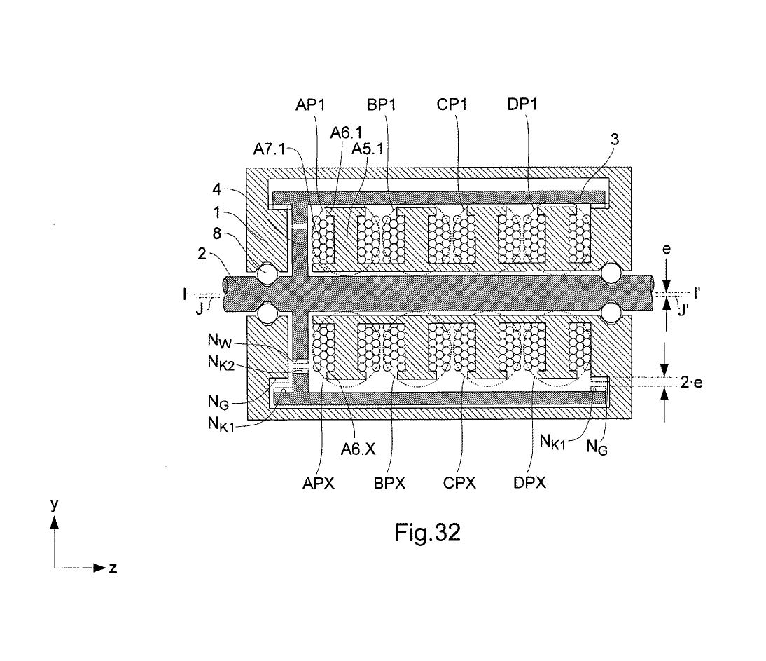

FIG. 32 shows a cylindrical design of the rotary drive having a plurality of internal stators, a hollow-cylindrical converter and a motor shaft which is led out on both sides,

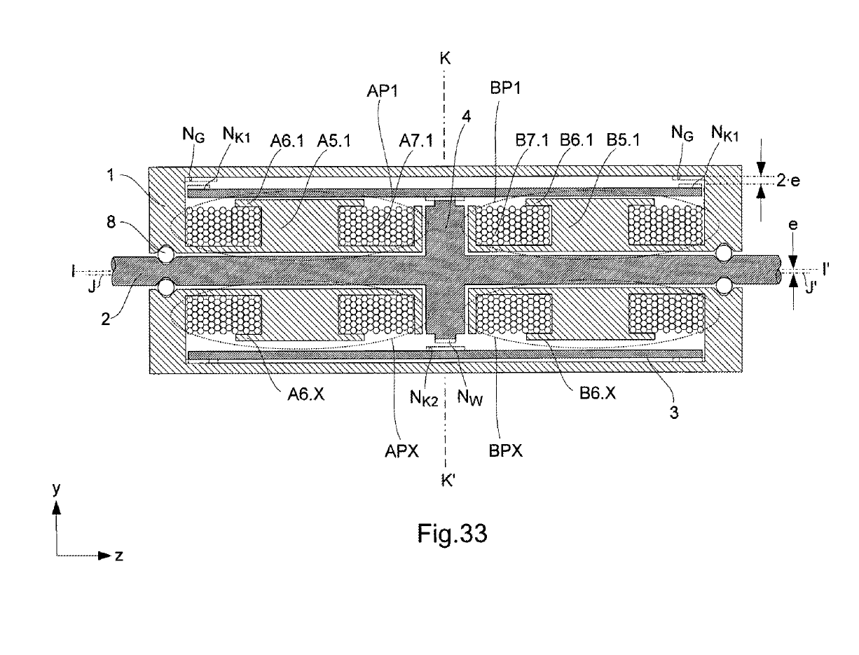

FIG. 33 shows a cylindrical design of the rotary drive having two internal stators which are arranged symmetrically with respect to the toothing system of the motor shaft, a hollow-cylindrical converter and a motor shaft which is led out on both sides,

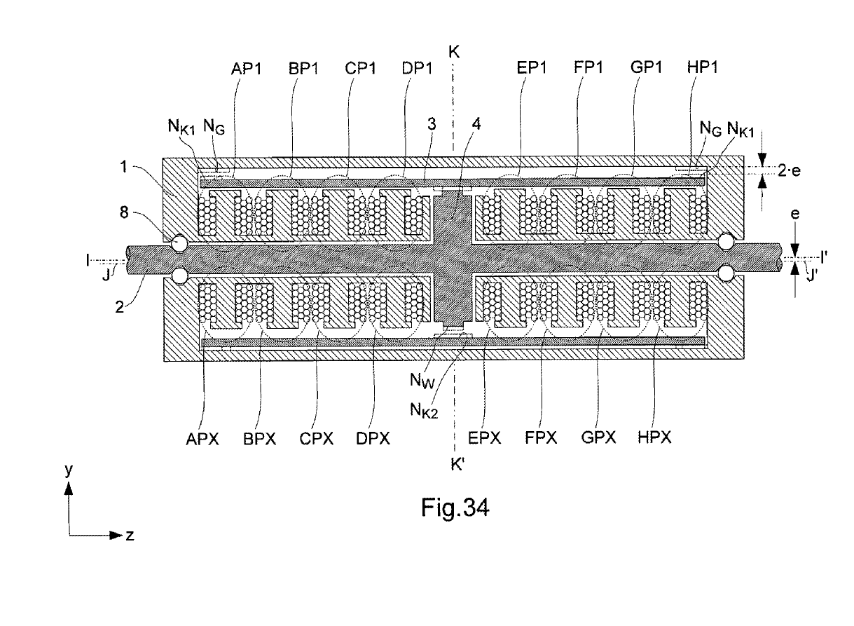

FIG. 34 shows a rotary drive according to FIG. 33 having a relatively high number of internal stators which are arranged symmetrically with respect to the toothing system of the motor shaft,

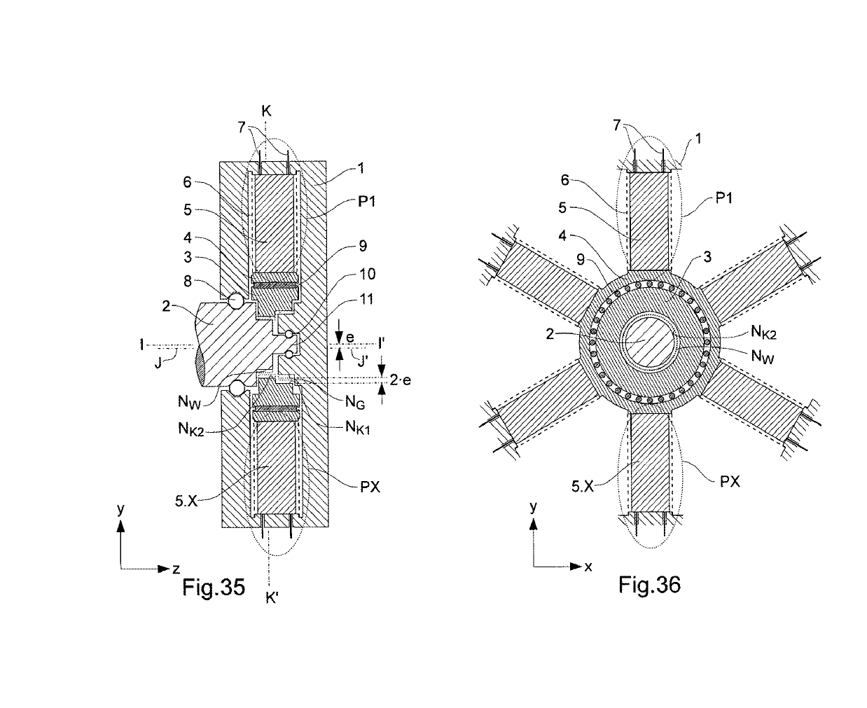

FIG. 35 shows a rotary drive with solid-state actuators as drive elements of the converter,

FIG. 36 shows a plan view of the rotary drive with solid-state actuators along the section K-K′ in FIG. 35,

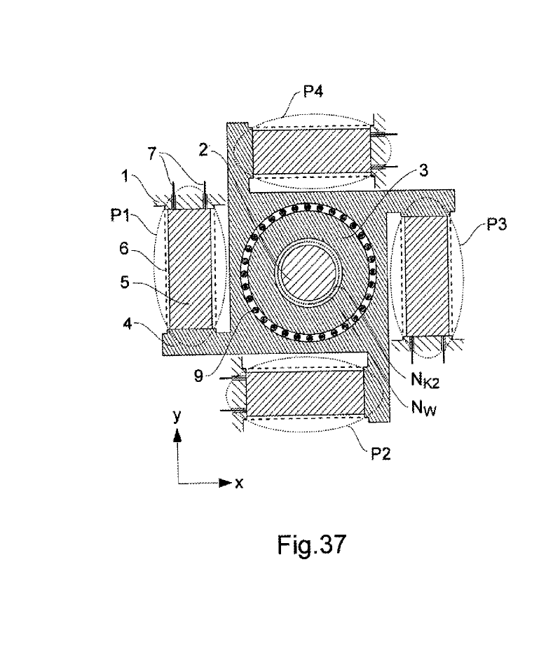

FIG. 37 shows a rotary drive with four solid-state actuators whose respective main direction of action is not directed onto the axis of the motor shaft,

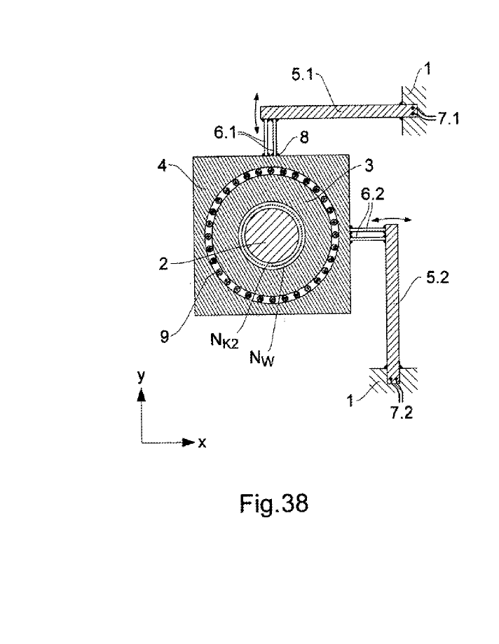

FIG. 38 shows a rotary drive with two bending actuators which are arranged at a 90 degree angle with respect to one another,

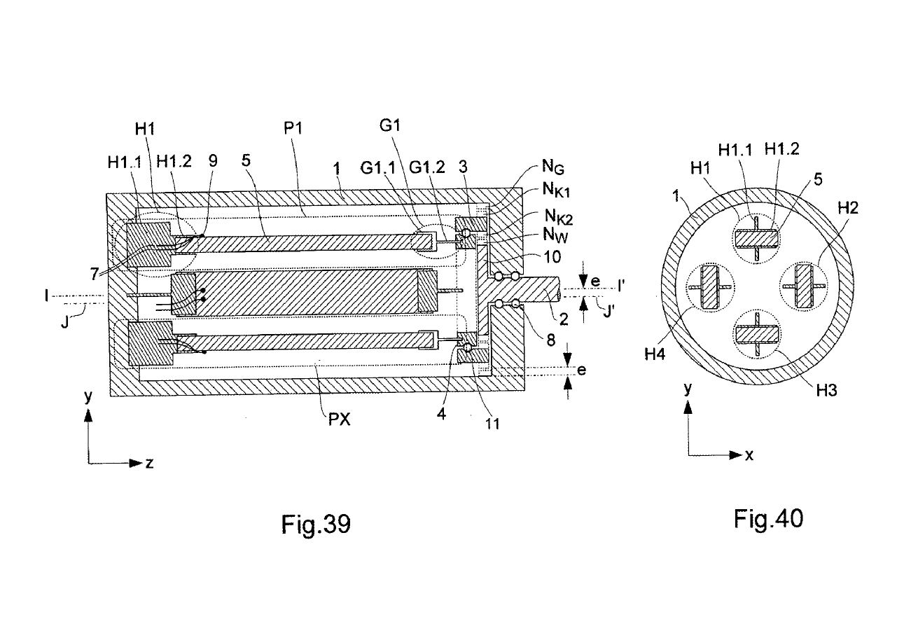

FIG. 39 shows a cylindrical rotary drive with four bending actuators which are oriented in the direction of the motor shaft axis,

FIG. 40 shows a sectional illustration of the rotary drive in the region of the bending actuator holders of the exemplary embodiment shown in FIG. 39,

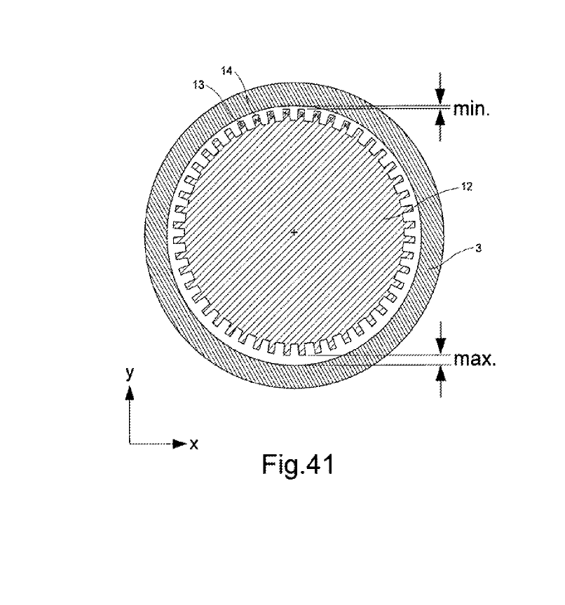

FIG. 41 shows a magnetic means for improving the transmission of force,

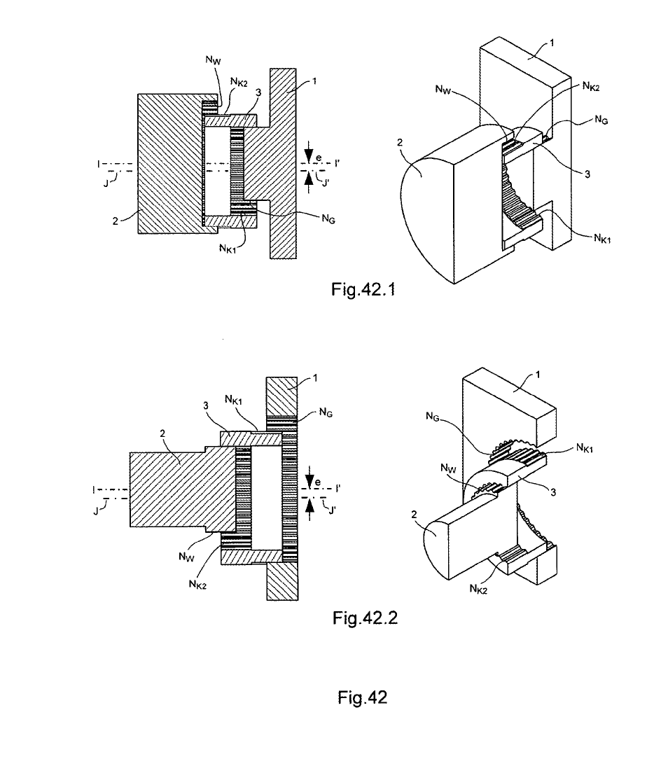

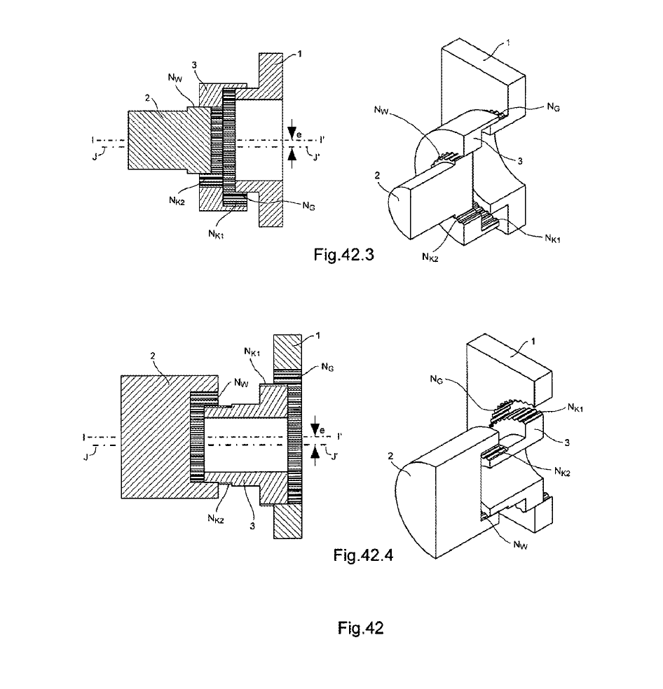

FIG. 42 shows basic variants of the rotary drive, in each case in a planar and perspective sectional view,

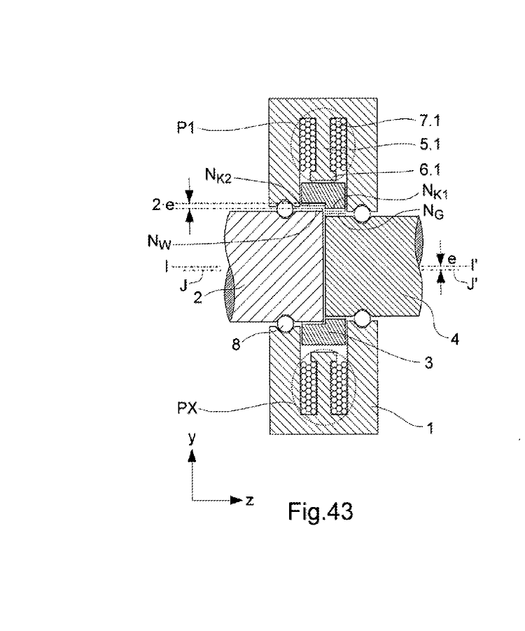

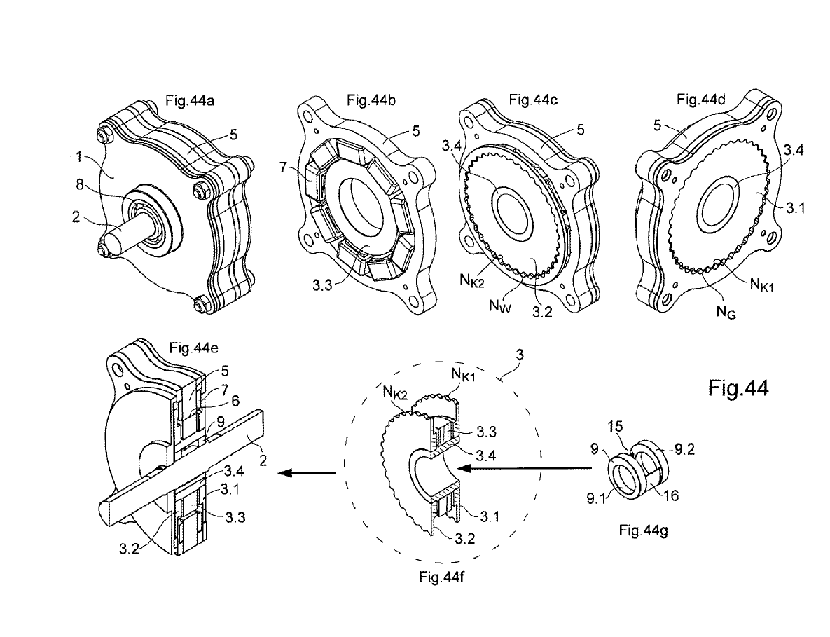

FIG. 43 shows a rotary drive with two shafts and power splitting, and

FIG. 44 shows a rotary drive with an installed converter and further motor components in perspective views.

FIG. 1 shows a sectional illustration in a plan view as a first exemplary embodiment of the rotary drive according to the invention. FIG. 2 shows the rotary drive from FIG. 1 in a plan view along a sectional plan K-K′ in FIG. 1. The rotary drive has as a first body a motor housing 1 in which a motor shaft 2 is mounted so as to be rotatable with respect to a said rotational axis I-I′, as a second body using bearings 8. The motor shaft 2 is secured against axial shifting along the rotational axis I-I′ either by the bearings 8 or by elements (not illustrated) such as shim rings, circlips, disk springs or the like. Furthermore, the rotary drive has magnetic poles P1, PX. The magnetic poles P and the elements of each magnetic pole 5, 6, 7 are indexed with the serial parameter X, wherein X is an integer in the range 1≦X≦i, where i≦2 and i=an integer. The number i therefore indicates the maximum number of magnetic poles of a rotary drive of the type according to the invention. For example, the rotary drive with i=8 which is shown in FIG. 2 has a total of eight magnetic poles P1, P2, P3, P4, P5, P6, P7 and P8. Each of the magnetic poles has a region of ferromagnetic material 5.1, 5.X which is surrounded by a winding 7.1, 7.X of electrically conductive insulated wire through which a flow of current and a magnetic field which acts outwardly in a substantially radial manner with respect to the rotational axis I-I′ can be generated by applying an electrical voltage. The magnetic poles P1, PX form electro-magnetic actuators through interaction with the ferromagnetic material of the converter 3. Alternatively, the magnetic poles themselves can also be considered to be actuators which act on the converter. This applies to the examples in all the figures unless stated otherwise. The magnetic poles are, as illustrated in FIG. 2, preferably arranged at equidistant angular intervals in a plane which is perpendicular to the motor shaft axis I-I′. Furthermore, each of the magnetic poles P1, PX has, at its outer circumference, a pole shoe 6.1, 6.X serving to conduct magnetic flux. The soft-magnetic materials of the magnetic poles are connected to one another in an internal central region 4. The approximately star-shaped body of the ferromagnetic material of the magnetic poles P1, PX with the winding packets 7.1, 7.X is referred to here as a stator. The stator is permanently connected to the motor housing 1 in the central region 4. At its motor-side end, the motor shaft 2 has an external toothing system N. Furthermore, the motor housing 1 has, at its region lying opposite the end side of the motor shaft 2, a pin-shaped elevated portion which is concentric with respect to the motor shaft axis I-I′ and has an external toothing system N_{G}. The external toothing systems of the motor shaft N_{W} and of the motor housing N_{G} are surrounded by an annular element which is referred to as a converter 3 and has soft-magnetic material at least in the region of the pole shoes 6.1, 6.X. The converter 3 has, at its two ends, internal toothing systems N_{K2} and N_{K1} which correspond to the external toothing systems of the motor shaft N_{W} and motor housing N_{G} and which can roll in the external toothing systems of the motor shaft 2 and motor housing 1. In order to ensure this, the toothing system regions of the converter 3 enclose those of the motor shaft 2 and motor housing 1 with an excess dimension. The internal toothing system N_{K2} of the converter 3 has at least one tooth more than the external toothing system N_{W} of the motor shaft 2. The internal toothing system N_{K1} of the converter 3 likewise has at least one tooth more than the external toothing system N_{G} of the motor housing 1. The toothing systems are embodied in such a way that for both toothing system pairings N_{K2}/N_{W} and N_{K1}/N_{G} an eccentricity e is produced which is as far as possible identical with respect to the motor shaft axis I-I′ and is represented in FIG. 1 by the axis J-J′. The maximum shifting path of the converter 3 therefore corresponds to twice the eccentricity e. The center axis of the internal faces of the converter 3, denoted by J-J′ in FIG. 1, can be shifted by at maximum the absolute value±e with respect to the motor shaft axis I-I′. The diameter of the toothing systems of the motor shaft 2 and the motor housing 1 can be selected randomly, in particular differently. In order to make the motor shaft 2 rotate, the magnetic poles P1, PX are energized in a rotating fashion.

As a result of the magnetic field forces, the converter 3 is respectively pulled in the direction of the energized magnetic poles, as a result of which the toothing systems of the converter 3 move completely into engagement with the motor housing toothing system N_{G} and the motor shaft toothing system N. The direction of the radially directed magnetic force vector acting on the converter 3 changes in phase with the rotating electrical energization of the frequency ωₑ₁ of the magnetic poles P1, PX, as a result of which the converter 3 rolls with its internal toothing system N_{K1} in the external toothing system N_{G} of the motor housing 1. As a result, the converter 3 is made to rotate, and on the other hand it carries out a superimposed circular shifting movement (=tumbling movement) with respect to the motor shaft axis I-I′, which movement leads to simultaneous rolling of the external toothing system N_{W} of the motor shaft 2 in the internal toothing system N_{K2} of the converter 3. The resulting rotational direction and rotational speed of the motor shaft 2 with respect to the motor housing 1 results from the superposition of these effects, as a result of which, depending on the configuration of the toothing system and combination of the toothing system designs (internal/internal, internal/external, external/internal, external/external) drives which have a very high, medium or low down step and a positive or negative rotational direction with respect to the direction of rotation of the electrical actuation frequency ωₑ₁ can be produced. The design and function of the rotary drive are illustrated further with respect to FIG. 2. FIG. 2 shows the rotary drive illustrated in FIG. 1 in a plan view along a section along the line K-K′ in FIG. 1. In the exemplary embodiment shown in FIG. 2, the rotary drive has eight magnetic poles P1 . . . P8. Generally, a magnetic pole is denoted by PX. The toothing systems N_{K1} and N_{K2} of the converter 3 are in engagement in the upper position in an engagement region with the toothing systems N_{W} of the motor shaft 2 and N_{G} of the motor housing 1 in FIG. 2 and are disengaged in the lower position. This is illustrated in FIG. 2 by the detail enlargements D1 and D1′. The eight windings 7.1 . . . 7.8 each have electrical connecting lines 9.X which are connected to motor control electronics (not illustrated). The converter 3 can be shifted by magnetic forces within the xy plane through rotating energization of the windings 7.1 . . . 7.8, wherein the toothing systems of N_{K1} and N_{K2} of the converter 3 roll in the toothing systems N_{W} of the motor shaft 2 and N_{G} of the motor housing 1, as a result of which the motor shaft 2 is made to rotate.

In the example according to FIG. 3, the rotary drive according to the invention has, as essential elements, the components having toothing systems comprising the motor shaft 2, the motor housing 1 and the converter 3 as well as drive actuators for the converter 3. The axis of the motor shaft 2 and the center point or the center axis of the motor housing toothing system N_{G} lie on a common axis I-I′ and are therefore concentric with respect to one another. The motor shaft 2 is mounted so as to be rotatable with respect to the motor housing 1 with respect to the axis I-I′ by bearing means (not illustrated in FIG. 3). The converter 3 can be shifted eccentrically about the common axis I-I′ of the motor shaft 2 and the motor housing toothing system N_{G} by actuators, preferably electro-magnetic actuators having a stator and magnetic poles, electro-static actuators, solid-state actuators (piezo-electric, electro-strictive, magneto-strictive, dielectric, MSM etc.), thermal actuators, pneumatic and hydraulic actuators, aero-dynamic actuators (wind power plant), water power actuators and internal combustion actuators (for example pistons of 2-stroke and 4-stroke spark ignition and diesel motors), which are not illustrated in FIG. 3 for reasons of clarity, wherein the center axis J-J′ of the converter 3 moves on a circular path with the eccentricity e about the common axis I-I′ of the motor shaft 2 and the motor housing toothing system N_{G}. The toothing systems are embodied in such a way that when the converter 3 shifts about the axis I-I′ they can roll one in the other. According to DIN 9107, half the maximum displacement travel e=(Xₘₐₓ−Xₘᵢₙ)/2 is denoted as eccentricity e in all the figures and descriptions. The converter 3 can optionally be guided in rotatable and radially displaceable fashion by means of an eccentric which is arranged on the axis I-I′ and is not illustrated in FIG. 3. The variants of the rotary drive according to the invention which are illustrated schematically in FIG. 3 are differentiated as a function of whether the toothing systems of the converter 3 are internal toothing systems or external toothing systems, as follows:

FIG. 3.1: The first toothing system of the converter N_{K1} is an internal toothing system, the second toothing system of the converter N_{K2} is an external toothing system: the rotational speeds of the two transmission stages are added. The rotational direction of the motor shaft is the same as the direction of rotation of the converter shift.

FIG. 3.2: The first toothing system of the converter N_{K1} is an external toothing system, the second toothing system of the converter N_{K2} is an internal toothing system: the rotational speeds of the two transmission stages are added. The rotational direction of the motor shaft is opposite to the direction of rotation of the converter shift.

FIG. 3.3: Both toothing systems of the converter N_{K1} and N_{K2} are internal toothing systems: the rotational direction of the first transmission stage is in the same direction as the direction of rotation of the electrical energization pattern, and the rotational direction of the second transmission stage is in the opposite direction to the direction of rotation of the electrical energization pattern. The rotational speeds of the two transmission stages are opposed. The resulting rotational direction of the motor shaft depends on the ratio of the transmission ratio of the first transmission stage to the second transmission stage and can both be in the same direction as the direction of rotation of the converter shift and in the opposite direction thereto.

FIG. 3.4: Both toothing systems of the converter N_{K1} and N_{K2} are external toothing systems: the rotational direction of the first transmission stage is in the opposite direction to the direction of rotation of the electrical energization pattern, and the rotational direction of the second transmission stage is in the same direction as the latter. The rotational speeds of the two transmission stages are opposed. The resulting rotational direction of the motor shaft depends on the ratio of the transmission ratio of the first transmission stage to the second transmission stage and can both be in the same direction as the direction of rotation of the converter shift and in the opposite direction thereto.

The following relationship for the rotational direction and rotational frequency Ω of the motor shaft 2 with respect to the motor housing 1 generally applies:

Ω={1−((N_{K2}·N_{G})/(N_{W}·N_{K1}))}·ωₑ₁ Eq. (1)

where
N_{G}—Number of teeth of the motor housing toothing system
N_{W}—Number of teeth of the motor shaft toothing system
N_{K1}—Number of teeth of the first toothing system of the converter
N_{K2}—Number of teeth of the second toothing system of the converter, and
ωₑ₁—Electrical actuation frequency (rotational frequency).

In contrast to FIG. 1, FIG. 4 shows an embodiment variant in which the motor shaft 2 is additionally rotatably mounted at its front-side end 9 either in the stator 4 connected to the motor housing 1 or in the motor housing 1 itself. As a result of the double mounting, radial forces acting on the motor shaft 2 can be taken up better and tilting of the motor shaft 2 can be minimized, which assists overall the satisfactory running of the toothing systems. For this purpose, the stator 4 can have a cutout 11 in which a front-side pin 10 of the motor shaft 2 is rotatably mounted by means of a bearing 9. All known bearing variants such as ball bearing, needle bearing, sliding bearing or the like can be used as bearings 9.

FIG. 5 shows an exemplary embodiment in which the motor shaft 2 is led out of the motor housing 1 on both sides and is additionally rotatably mounted in the way already described in FIG. 4.

FIG. 6 shows a special case of the rotary drive in which the toothing systems have identical diameters. A rotation of the motor shaft requires, according to equation (1), that the toothing system pairings N_{K1} with N_{G} and N_{K2} with N_{W} are embodied in this special case in such a way that the transmission ratios of the two toothing system pairings are not identical. This can be achieved, for example, by means of different differences in the number of teeth and/or different tooth geometries.

FIG. 7 shows an exemplary embodiment in which the toothing systems N_{K1} and N_{K2} of the converter 3 are both internal toothing systems, wherein the diameter of the toothing system N_{K2} is larger than that of the toothing system N_{K1}. In particular, if the toothing systems have a same tooth modulus and an identical eccentricity e, this results in a rotation of the motor shaft 2 with a rotational direction in the direction of rotation of the electrical excitation frequency ωₑ₁ of the stator poles P1, PX.

FIG. 8 shows an exemplary embodiment with an external toothing system N_{K1} and an internal toothing system N_{K2} of the converter 3, which leads to a rotation of the motor shaft 2 in the opposite direction to the direction of rotation of the electrical excitation frequency ωₑ₁ of the stator poles P1, PX.

FIG. 9 shows an exemplary embodiment with an internal toothing system N_{K1} and an external toothing system N_{K2} of the converter 3, which leads to a rotation of the motor shaft 2 in the direction of rotation of the electrical excitation frequency ωₑ₁ of the stator poles P1, PX.

FIG. 10 shows an exemplary embodiment in which the toothing systems N_{K1} and N_{K2} of the converter 3 are both external toothing systems, wherein the diameter of the toothing system N_{K2} is larger than that of the toothing system N_{K1}. In particular, given identical eccentricity and an identical tooth modulus of the toothing systems, this results in a rotation of the motor shaft 2 in the opposite direction to the direction of rotation of the electrical excitation frequency ωₑ₁ of the stator poles P1, PX.

FIG. 11 shows an exemplary embodiment in which, compared to FIG. 10, the diameter N_{K1} is larger than the diameter N_{K2}. This results in a rotation of the motor shaft 3 in the direction of rotation of the electrical excitation frequency ωₑ₁ of the stator poles P1, PX.

In order to clarify the configuration possibilities, FIG. 12 shows a variant in which the diameter of the internal toothing system N_{K2} is considerably smaller than the diameter of the external toothing system N_{K1}.

According to equation (1), the overall transmission ratio Ω/ωₑ₁ can be determined by selecting the number of teeth of N_{K1}, N_{K2}, N_{G}, N_{W} within wide limits. If possible, the toothing systems will be configured in such a way that the eccentricity for the two toothing system pairings N_{K1} with N_{G} and N_{K2} with N_{W} is identical. However, all that is necessary for the function of the rotary drive is engagement of the teeth of the toothing systems. The eccentricities can accordingly differ from one another as long as a positively engaging engagement of the tooth is ensured.

FIG. 13 shows a variant of the rotary drive with an external stator or stator poles P1, PX. The pole shoes 6.1, 6.X act from the outside on the ferromagnetic converter 3. FIG. 13 shows a special case which is analogous to the exemplary embodiment shown in FIG. 6 in which the toothing systems have identical diameters. A rotation of the motor shaft 2 requires, according to equation (1), that the toothing system pairings N_{K1} with N_{G} and N_{K2} with N_{W} are embodied in this special case in such a way that the transmission ratios of the two toothing system pairings are not identical. This can be achieved, for example, by different differences in the number of teeth and/or different teeth geometries.

FIG. 14 shows a further variant of the rotary drive with an external stator or stator poles P1, PX in which the toothing systems N_{K1} and N_{K2} of the converter 3 are both internal toothing systems, wherein the pitch circle diameter of the toothing system N_{K1} is larger than that of the toothing system N_{K2}.

FIG. 15 shows an exemplary embodiment which is complementary to FIG. 14 and in which the toothing systems N_{K1} and N_{K2} of the converter 3 are both internal toothing systems, but the diameter of the toothing system N_{K1} is smaller than that of the toothing system N_{K2}.

FIG. 16 shows a variant of the rotary drive with an external stator or stator poles P1, PX in which the internal toothing system N_{K2} of the converter 3 has a significantly larger diameter than the external toothing system N_{K1}.

FIG. 17 shows an exemplary embodiment of the rotary drive with an external stator or stator poles P1, PX in which the external toothing system N_{K2} of the converter 3 has a significantly smaller diameter than the external toothing system N_{K1}.

FIG. 18 shows an exemplary embodiment of the rotary drive with an external stator or stator poles P1, PX in which both toothing systems of the converter 3 are external toothing systems, wherein the toothing system N_{K1} has a larger diameter compared to the toothing system N_{K2}.

FIG. 19 shows an exemplary embodiment of the rotary drive, for even higher torques, in which the converter is driven by external stator poles AP1, APX and internal stator poles BP1, BPX.

FIG. 20 shows an exemplary embodiment of the rotary drive with a power split on two motor shafts 2, 4. If both motor shafts 2, 4 are output motor shafts on which external load torques act, the function corresponds largely to that of an electrically driven differential, i.e. the electro-mechanical power of the rotary drive is distributed between the two output motor shafts in accordance with the external load torques acting on the motor shaft 2 and the motor shaft 4. If, for example, the motor shaft 2 is fixed with respect to the motor housing 1, the entire drive power is transmitted to the motor shaft 4. Conversely, when the motor shaft 4 is fixed, the entire power is transmitted to the motor shaft 2. If equally large load torques act on both motor shafts, the drive power of the rotary drive is distributed between both motor shafts. If the external load torques acting on the motor shaft 2 and the motor shaft 4 are unequal, the power splitting is proportional to the ratio of the external load torques. The principle of power splitting between two motor shafts can be applied to all the designs and variants of the rotary drive according to the invention which are covered by this document. The various variants are therefore not illustrated in particular.

However, in the case of the rotary drive illustrated in FIG. 20, one of the motor shafts can also be a (driven) input motor shaft and the respective other motor shaft can be an output motor shaft (power take off). As a result, the input motor shaft can be driven directly or indirectly by means of mechanical transmission means such as, for example, a chain, a toothed belt, a shaft, by means of some other drive, for example an electric motor, an internal combustion engine, by wind force, by hydraulic forces or by water forces, and the output motor shaft can drive a load, for example the camshaft of a motor vehicle. If the input motor shaft rotates with the mechanical rotational frequency ω_{E}, phase-rigid coupling of the input motor shaft to the output motor shaft can be achieved by phase-synchronous actuation of the stator means (for example electromagnets as in FIG. 20) P1, PX having or being composed of the coil 7.X, core 5.X and pole shoe 6.X with the electrical rotational frequency ωₑ₁=ω_{E}, during which phase-rigid coupling the output motor shaft moves in a phase-rigid fashion with the same rotational frequency ω_{E} as the input motor shaft. The power of the input motor shaft of the rotary drive is transmitted here virtually free of loss to the output motor shaft by the positively engaging connection of the input motor shaft to the output motor shaft via the converter 3. In order to detect the input motor shaft rotational speed and/or the output motor shaft rotational speed the rotary drive has sensor means, for example Hall sensors, encoders and electrical evaluation and actuation means (actuation electronics and MC software) (not illustrated in FIG. 20). By increasing or reducing ωₑ₁ it is furthermore possible to set a positive or negative differential rotational speed between the input motor shaft and output motor shaft. The differential rotational speed can be made chronologically variable through the frequency modulation and/or phase modulation of ωₑ₁. For example, through periodic phase modulation of ωₑ₁ it is possible to periodically move the output motor shaft in advance and/or into a retarded position with respect to the input motor shaft in terms of the absolute phase of ω_{E}. The rotary drive which is shown in FIG. 20 can therefore carry out the function of a phase shifter. Such phase shifters are used, for example, for camshaft adjustment in the case of motor vehicle internal combustion engines in order to control inlet times and outlet times of the inlet and outlet valves in a characteristic-diagram-dependent fashion. In particular, the main drive power of the output motor shaft of the rotary drive is made available here by the input motor shaft, while the rotary drive only needs to make available the power required to adjust the output motor shaft with respect to the input motor shaft. The input motor shaft and output motor shaft are interchangeable in their function, i.e. each of the motor shafts 2, 4 in FIG. 20 can serve as an input motor shaft or output motor shaft.

The converter 3 which is moved eccentrically about the motor axis I-I′ constitutes an imbalance. Such imbalances generate, as is known, destructive motor vibrations and noise and are to be avoided. For this purpose, the exemplary embodiment in FIG. 21 specifies a solution in which the imbalance which is caused by the converter 3 is compensated by a balancing mass 9 which rotates in a phase-synchronous fashion about the axis of the motor shaft I-I′. In particular, a ferromagnetic balancing mass 9 can be driven in the magnetic force bypass of the converter 3 in conjunction with the stator 4 and the stator poles P1, PX. As illustrated in FIG. 21, when the stator pole P1 is energized the converter 3 is attracted magnetically by said stator pole P1, as a result of which the center of mass of the converter 3 in FIG. 21 is moved downward along the y axis. At the same time, the disk-shaped ferromagnetic balancing mass 9 which is mounted in the interior of the converter 3 is pulled into an upper position along the y axis by magnetic forces transmitted by the converter 3. The distances and eccentricity of the balancing mass 9 are dimensioned in such a way that the distance of the balancing mass 9 from the converter 3 will be as small as possible here without these elements being in contact. Given suitable dimensioning, complete compensation of the motor imbalance can be achieved by means of the opposing movements of the centers of mass of the converter 3 and the balancing mass 3, during which compensation the common center of mass of the converter 3 and balancing mass 9 come to rest on the axis of the motor shaft I-I′ in every operating state. Since the balancing mass 9 moves in a phase-rigid fashion with the eccentrically rotating converter 3, the rotary drive is completely balanced in all operating phases. The balancing mass 9 is held displaceably and free of play in abutment with the stator core 4 by means of the elements of the securing disk 10, ball bearing 10 and spring washer 11. As a result of the shifting of the balancing mass 9 in phase-synchronism with the converter, said balancing mass 9 rolls with its internal region on the pin 14, arranged concentrically with respect to the motor shaft axis, of the stator and as a result is made to rotate itself. Basically, it therefore does not require any further ball bearing mounting of the balancing mass 9 on the pin 14, but such mounting is optionally possible. The intrinsic rotation of the balancing mass does not have any influence on the function of the rotary drive, nor does it disrupt it. The engagement conditions of the toothing systems in the position of the converter 3 shown in FIG. 21 are illustrated schematically by the detail enlargements D1 and D1′ as well as D2 and D2′ which are rotated through 90 degrees in terms of perspective.

FIG. 22 shows a further exemplary embodiment for compensating imbalance, in which the balancing mass 9 is driven electro-magnetically in phase-synchronism with the converter 3 by an additional auxiliary stator composed of or having the stator poles H1, HX with the windings 10.1, 10.X. The energization of the auxiliary stator poles H1, HX occurs in turn in such a way that the common center of mass of the balancing mass 9 and the converter 3 lies on the motor shaft axis I-I′ in all operating phases. Since the balancing mass 9 does not perform any work with the exception of overcoming its own inertia, the energy requirement for the auxiliary stator windings H1, HX is low. The windings 10.1, 10.X of the auxiliary stator can therefore be embodied compactly with a thin wire and optionally connected electrically to the main stator windings 7.1, 7.X. The engagement conditions of the toothing systems in the position of the converter 3 shown in FIG. 22 are illustrated schematically by the detail enlargements D1 and D1′ as well as D2 and D2′ rotated in perspective through 90 degrees.

The dimensioning of the balancing mass 9 with respect to the converter 3 for performing complete imbalance compensation can be carried out both by means of the thickness and by means of the shape of the disk-shaped balancing mass 9. FIG. 23.1 shows in this respect as an example a balancing disk 9 whose thickness and density are suitably selected. Likewise, the opposing imbalance can be influenced by means of the shape of the balancing mass. As an example of this, FIG. 23.2 shows a balancing mass 9 in the form of a wide-edged ring, and in FIG. 23.3 in the form of a thin-edged ring. The disk-shaped or annular balancing masses 9 roll with their internal surface on the outside of the pin 14, symmetrical about the axis of the motor shaft I-I′, of the stator or motor housing. Depending on the difference in the diameters of the internal drilled hole of the balancing disk and the external diameter of the stator pin 14, the balancing masses rotate to a greater or lesser extent in themselves, which, however, does not influence the function.

In contrast to the balancing masses shown in FIG. 23 with a rotationally symmetrical shape, FIG. 24 shows non-rotationally symmetrical balancing weights 9 which rotate around the motor shaft axis. FIG. 24.1 shows a ferromagnetic balancing weight in the form of an homogenous body with a suitable thickness and density, which body is mounted so as to be rotatable with respect to the motor shaft axis I-I′ by means of the bearing 8. The ferromagnetic balancing weight 9 is moved in phase-synchronism with this body 3 by the magnetic forces which are transmitted by the eccentrically moved converter 3 since said balancing weight 9 always moves into the position in which the distance between the converter 3 and the balancing weight 9 is at a minimum. The balancing weight 9 rotates here with the rotational frequency of the electrical excitation frequency ωₑ₁.

The balancing weight mass can be adjusted by means of subsequently formed cutouts or drilled holes 15, as is shown schematically in FIG. 24.2 or by additional weights 16, as shown in FIG. 24.3.

Instead of and/or in addition to the magnetic field lines starting from the converter 3 and the magnetic forces acting on the balancing weight 9, the balancing weight 9 can have a permanent magnet, as a result of which it always adopts the position of the shortest distance from the converter 3 and also moves in a phase-rigid fashion with the electrical excitation frequency ωₑ₁. This embodiment is analogous to the embodiment illustrated in FIG. 24.3, wherein the element denoted by the number 16 now represents a permanent magnet.

FIG. 25 shows an embodiment of the rotary drive according to the invention in which the converter 3 is guided in a rotatable and displaceable fashion by an eccentric 9. For this purpose, the eccentric 9, is mounted in an eccentrically rotatable fashion with a drilled hole 9.1 on a bolt 14 of the motor housing 1. At the same time, the eccentric 9 is fitted in a play-free and rotatable fashion with its cylindrical external surface 9.2 into an internal drilled hole of the converter 3. The eccentricity and the dimensions of the eccentric 9 are therefore matched to the eccentricity e of the converter 3 with respect to the motor shaft toothing system N_{W} and the motor housing toothing system N_{G} and the toothing systems N_{G}, N_{W}, N_{K1} and N_{K2} in such a way that the toothing systems can engage one in the other and roll. If electro-magnetic forces are applied to the converter 3 by the stator poles P1, PX, the converter 3 can therefore both move eccentrically and rotate. In the motor mode, the eccentric 9 rotates with the electrical excitation frequency ωₑ₁ about the axis I-I′ of the motor shaft 2. In order to mount the eccentric 9 free of friction on the bolt 14 of the motor housing 1, on the one hand, and in the converter 3, on the other, bearing means corresponding to the prior art, for example sliding bearings, ball bearings, needle bearings or the like can be used, wherein the bearing is to be embodied as free of play as possible. The embodiment variant illustrated in FIG. 25 shows a sliding bearing of the eccentric 9. In particular, by suitable dimensioning of the eccentric 9 it is possible to achieve positive guidance of the converter 3 which ensures that the toothing system pairings N_{W} with N_{K2} and N_{G} with N_{K1} are always in engagement.

A further advantage of the variant shown in FIG. 25 is that the eccentric 9 which rotates in a phase-rigid fashion with the electrical excitation frequency about the motor shaft axis I-I′ can serve to compensate the motor imbalance which is caused by the eccentrically shifted and rotating converter 3. With respect to FIG. 25, FIG. 26.1 shows an embodiment of the eccentric 9 in which the latter has for this purpose cutouts and/or drilled holes 15 on its one half face. The cutouts 15 are located here in the region of the eccentric 9 where the latter has the greater width, with the result that the center of mass of the eccentric in FIG. 26.1 is shifted upward in the direction of the positive y axis. The center of mass of the converter 3 is shifted downward in the position shown in FIG. 25, along the negative y axis. By suitably dimensioning and arranging the cutouts 15 of the eccentric 9 it is possible to ensure that the entire center of mass of the converter 3 and eccentric 9 always lies on the motor shaft axis I-I′, as a result of which the motor has complete mass balancing and runs free of vibrations. Instead of the cutouts 15 of the eccentric 9, it is possible, as shown in FIG. 26.1, for the eccentric 9 also to have additional masses 16 in its region of relatively small width. FIG. 26.2 gives an example of this. This may also involve material regions with a relatively high density. This measure also causes the center of mass of the eccentric 9 to be shifted in the desired way. The measures illustrated in FIG. 26.1 and FIG. 26.2 can also be combined with one another.

FIG. 27 shows a particularly flat embodiment variant of the rotary drive with internal stator, in which embodiment the converter 3 is embodied in the form of a U-shaped annular profile.

FIG. 28 shows a particularly flat embodiment variant of the rotary drive with an external stator, in which embodiment the converter 3 is embodied in the form of a U-shaped annular profile.

With the exception of the rotary drives in which the converter 3 is mounted by eccentric means 9, in all the other embodiment variants of the rotary drive tilting of the converter 3 can be prevented by virtue of the fact that the latter is guided in parallel by corresponding surfaces of the motor housing 1, of the motor shafts 2 or of the other components of the rotary drive. Both sliding bearings and ball bearings, needle bearings or other bearings (for example magnetic, hydrostatic, hydrodynamic bearings) are suitable for parallel guidance of the converter 3.

FIG. 29 shows a flat embodiment of the rotary drive according to the invention in which the motor shaft 2, 2′ is guided through the motor housing 1, 4 with the result that the two coupled output shafts comprising the motor shaft 2 and motor shaft 2′ are available for driving the loads or for assisting a rotational movement. For example, the motor shaft 2′ can be connected to the steering gear of a motor vehicle, and the motor shaft 2 to the steering wheel, wherein the rotary drive can apply a force which assists the steering in a desired fashion.

In contrast to this, the variant illustrated in FIG. 30 shows a rotary drive according to the invention in which the motor shaft is embodied in the form of an external ring 2 or of an external disk 2 which is mounted so as to be rotatable by external bearing means 8.

The variant shown in FIG. 31 has an installed converter 3 which has two disks 3.1 and 3.2 which are connected to one another, or said converter 3 is composed of said disks 3.1 and 3.2 which have on their outer circumference toothing systems N_{K1} and N_{K2}, and of a ferromagnetic ring 3.3 which is connected to the disk 3.2. This permits particularly economic production since the individual elements 3.1, 3.2 and 3.3 can be manufactured and tested individually, for example by punching, and connected to the converter 3 by means of known connection and joining techniques. The output element has in FIG. 31 the form of an external ring/disk 2 which is mounted so as to be rotatable about the motor shaft axis I-I′ by bearing means 8.

The principle according to the invention is suitable for manufacturing rotary drives with a wide variety of designs and aspect ratios. As an example of this, FIG. 32 shows a rotary drive with a longitudinal extent along the z axis (motor shaft axis) which is large with respect to the xy extent. The motor housing 1 has for this purpose at least one stator ring with the stator poles AP1, APX, but preferably a plurality of stator rings with indexes A, B, C and D in FIG. 32. Each stator ring has cores A5.X of a ferromagnetic material, pole shoes A6.X and windings A7.X. In particular, the rotary drive illustrated in FIG. 32 has a plurality of such stator rings, denoted in FIG. 32 by the letters A, B, C, D, each of which has a number of stator poles APX, BPX, CPX, DPX. The individual stator rings can have a number of stator poles which differ from one another. However, in particular the individual stator rings have the same number of stator poles, with the result that in FIG. 32 in each case the windings A7.1, B7.1, C7.1, D7.1, the windings A7.2, B7.2, C7.2, D7.2 and the windings A7.X, B7.X, C7.X, D7.X are or can be electrically connected to one another or together form one winding. The multiplicity of stator rings and stator poles serves to increase the power and the torque of the rotary drive.

The internally guided motor shaft 2 can be mounted doubly in the motor housing 1 and guided through the motor housing, as a result of which two connections are available on the output side. The motor shaft 2 is rotatably mounted in the motor housing 1 by means of bearing means 8 and secured axially against migration. At its one housing-side end, the motor shaft 2 has a disk-shaped region 4 with an external toothing system N. The hollow-cylindrical converter 3 has the at least one internal toothing systems N_{K1} and N_{K2}. Likewise, the motor housing 1 has the at least one external toothing system N_{G} corresponding to the internal toothing system N_{K1} of the converter 3. Through rotational energization of the windings A7.1, A7.2, A7.3 . . . as well as B7.1, B7.2, B7.3 . . . to D7.1, D7.2, D7.3, . . . the converter 3 is shifted in a rotational fashion by magnetic forces and the toothing systems roll one in the other. As a result, the converter 3 is made to rotate, wherein an eccentric movement is superimposed on the converter movement (tumbling), as a result of which the motor shaft 2 is made to rotate.

FIG. 33 shows a rotary drive of the type presented in FIG. 32 which is mirror-symmetrical with respect to the axis K-K′ and in which the disk-shaped region 4 is located with the external toothing system N_{W} in the motor center and the hollow-cylindrical converter 3 has two external toothing systems N_{K1} at its two ends, which external toothing systems N_{K1} can be engaged with internal toothing systems N_{G} of the motor housing 1 and can roll one in the other by electro-magnetic shifting of the converter 3. Tilting moments acting on the converter 3 are minimized by the symmetrical design. The rotary drive has at least one stator ring A and B respectively on the right and left of the disk-shaped region 4. The stator poles lying to the left of the disk-shaped region 4 in FIG. 33 are denoted by AP1, APX, and the stator poles lying to the right thereof are denoted by BP1, BPX. The motor shaft 2 is led out of the motor housing 1 on both sides.

As an extension of the variant illustrated in FIG. 33, FIG. 34 shows the possibility of cascading the stator rings lying to the right and left of the disk-shaped region 4. The design according to FIG. 34 has the four stator rings A, B, C, D to the left of the axis of symmetry K-K′, and the four stator rings E, F, G, H to the right of the axis of symmetry. In principle there are no restrictions with respect to the number of stator rings and the motor length, and in this way it is possible to form a very thin, long and powerful rotary drives.

The rotary drives according to the invention are suitable for purely open-loop controlled operation (feed-forward control) since the electrical and mechanical phase (=motor shaft adjustment) are correlated unambiguously.

The position and movement of the converter and therefore the motor shaft can be determined by means of inductive, capacitive, optical, impedance measurements, current and voltage measurements or other physical methods. In particular, the windings, for example 7.1, 7.X of the stator poles, can serve themselves as sensors for the determination of the converter position and the converter movement and therefore the motor shaft position and the motor shaft rotation by means of the above physical measuring methods. Furthermore, the above measuring methods are suitable for detecting the load torques which act on the motor shaft 2 or the motor shafts 2, 2′. Utilizing the windings, for example 7.1, 7.X and the inductances thereof, an additional sensor system is not necessarily required for this purpose. In order to detect the converter movement/position and/or the rotational speeds and/or the angular positions and/or torques of the first body with respect to the carrier structure and/or of the second body with respect to the carrier structure and/or between the first body and the second body it is also possible to provide external sensors, such as for example Hall sensors, which detect the position of the converter relative to the motor housing. If the actuators are other actuators than electromagnets, in particular piezo-electric actuators, they can also extract sensor information from the current signals, voltage signals and charge signals thereof and use them to perform open-loop and closed-loop control of the rotary drive. In particular, a load torque can be a torque.

On the one hand, as well as the electromagnets all types of actuators which can apply forces to the converter in a contactless fashion by means of field effects are suitable as drive elements for the rotary drive according to the invention. In particular, electro-static actuators, in particular electro-static comb actuators (comb drives) and in particular electro-static actuators manufactured using MEMS technology are also suitable. Furthermore, the rotary drive according to the invention can be partially or entirely produced as a micro-mechanical and/or micro-electromechanical component.

Furthermore, the rotary drive according to the invention is also suitable for actuators which are mechanically coupled to the converter 3, in particular piezo-electric actuators, magneto-strictive actuators, magnetic shape memory actuators, dielectric actuators, thermo-bimetal actuators etc. Further exemplary embodiments with explanations of the design and the function in this regard follow:

The rotary drive which is shown in section in FIG. 35 and in plan view in FIG. 36 along a section K-K′ in FIG. 35 has solid-state actuators 5, 5.X for driving the converter 3. In particular piezo-electric multi-layer actuators (piezo-electric multi-layer stacks) are suitable as solid-state actuators 5, 5.X, said actuators becoming longer and/or contracting when an electrical voltage is applied to the contact pins 7 of the solid-state actuator as a function of the polarity and the amplitude of the electrical voltage. The main axes of action of the solid-state actuators illustrated in FIG. 35 extend along the y axis. The solid-state actuators 5, 5.X are supported by their one end on the motor housing 1, and by their other end on an annular drive ring 4 which surrounds the converter 3. The solid-state actuator can be protected against environmental influences, in particular moisture, by means of the elements 6 which surround the solid-state actuators 5.X. The elements 6 can also have the function of spring elements which mechanically prestress the solid-state actuators and mechanically secure them between the motor housing 1 and the drive ring 3.

The drive ring 4 is rotatably mounted with respect to the converter 3, as illustrated in FIG. 36, by means of bearing means 9, suitable for these as such are needle bearings, ball bearings, sliding bearings or other bearing means corresponding to the prior art. The converter 3 has toothing systems N_{K1} and N_{K2} which can roll in the toothing systems N_{G} of the motor housing 1 and N_{W} of the motor shaft 2 and as a result cause the motor shaft 2 to undergo controllable rotation in the fashion already described. The motor shaft 2 is rotatably mounted in the motor housing 1 by means of bearing means 8. In addition, the motor shaft 2 can be mounted in an end-side region 11 by means of further bearing means 10 in the motor housing 1. As a result, a particularly high level of radial rigidity of the motor shaft is achieved, which is advantageous given the strong forces of piezo-electric actuators. The additional bearing of the motor shaft 2 in a region 11 with the bearings 10 is, however, irrelevant for the function of the rotary drive. The rotary drive illustrated in FIG. 35 is therefore largely analogous in function and design to those shown in FIG. 1 and FIG. 14, with the difference that instead of electro-magnetic actuators, here solid-state actuators are used to excite a circular shifting movement of the converter 3. In the same way, the design and function of the rotary drive with solid-state actuators shown in plan view in FIG. 36 largely corresponds to the rotary drive with electro-magnetic actuators illustrated in FIG. 2.

However, in contrast to the rotary drives in which the forces are transmitted to the converter by means of electro-magnetic fields (in a non-positively engaging fashion), the mechanically fixed (positively engaging) connection of the solid-state actuators to the mechanism of the rotary drive advantageously has as an additional element a drive ring 4 which is rotatably mounted with respect to the converter 3. By means of the rotary bearing of the converter 3 in the drive ring 4, the forces and deflections which are generated by the solid-state actuators 5 are transmitted to the converter 3 without the rotation and circular shifting movement thereof being adversely affected. In this way, a rotating circular shifting movement of the converter 3 is brought about through rotating electrical excitation of the solid-state actuators, wherein the toothing systems roll one in the other in the way already described in detail, and cause the motor shaft to rotate. A slight shearing load of the solid-state actuators does not adversely affect either the function of the rotary drive or the service life of the solid-state actuators. If appropriate, the shearing load of the solid-state actuators can be reduced further or entirely avoided by additional kinematic elements such as solid-state joints, connecting links, parallel kinematics, eccentrics, etc.

The rotary drive shown in FIG. 35 and FIG. 36 has at least two drive actuators P, PX which are not arranged parallel to one another with their main axes of action and are arranged at an angle to the motor shaft axis I-I′. The maximum number i of drive actuators is not limited in the upward direction. The drive actuators which are preferably arranged in a plane perpendicular to the motor shaft axis I-I′ are referred to as a stator ring. The rotary drive according to the invention can have any desired number of stator rings which are arranged along the motor shaft axis I-I′. A symmetrical arrangement of a plurality of drive actuators at equidistant distances about the motor shaft axis I-I′ is particularly advantageous with respect to the uniformity of rotation and the actuation capability. In the case of the rotary drive shown in FIG. 35 and FIG. 36, the main direction of action of each individual drive actuator P is directed approximately onto the motor shaft axis I-I′.

The rotary drives illustrated in FIG. 33, FIG. 34, FIG. 35 are distinguished, in particular, by virtue of the fact that they can have more than one first converter toothing system N_{K1} and more than one housing toothing system N_{G}. There is also provision that the rotary drives have more than a second converter toothing system N_{K2} and more than one shaft toothing system N_{W}. This applies to all the rotary drives according to the invention.

As FIG. 37 shows, the main direction of action of each individual drive actuator P does not, however, necessarily need to be directed onto the motor shaft axis I-I′. The exemplary embodiment illustrated in FIG. 37 has four drive actuators P1, P2, P3 and P4, the main directions of action of which lie in a plane perpendicular to the motor shaft axis I-I′, wherein the main direction of action of each individual actuator is not directed to the motor shaft axis I-I′. For the rotational operation of the motor shaft 2, the converter 3 is excited to undergo a circular shifting movement in the xy plane about the motor shaft axis I-I′. For this purpose, in each case two drive actuators located opposite one another, for example P1 and P3 or P2 and P4 are actuated together electrically, with a phase offset between the two drive actuator pairs. In the arrangement according to FIG. 37, the phase offset between the periodic signal voltages of the two drive actuator pairs, P1, P3 and P2, P4 is preferably 90 degrees. The drive actuators P can carry out both positive and negative deflections, i.e. both contract and expand, with respect to a central position by means of, for example, corresponding electrical bias. The actuation of two drive actuators P1 and P2 as well as P2 and P4 which lie opposite one another is carried out in such a way that the drive ring 4 is shifted in the xy plane. In the arrangement shown in FIG. 37, this can be brought about by virtue of the fact that drive actuators which lie opposite one another have opposing bias voltages applied to them. Consequently, only shifting movements of the drive ring 4 are transmitted to the converter 3 by the rotational bearing of the converter 3 in the drive ring 4, but rotational movements of the drive ring 4 about the motor shaft axis I-I′ are not transmitted. Thermal changes in length of the drive actuators can therefore not be transmitted to the converter and adversely affect the function of the rotary drive. As a result, the rotary drive shown in FIG. 37 has a high degree of operational stability over a large temperature range.

The number of the drive actuators of a stator ring and the number of the stator rings is not limited.

In the plan view of a rotary drive shown in FIG. 38, bending actuators 5.1, 5.2, in particular piezo-electric bending actuators, serve to excite the eccentric converter movement.

The converter has, according to FIG. 3, two toothing systems N_{K1} and N_{K2} which roll in toothing systems N_{G} of the motor housing and N_{W} of the motor shaft and can cause the motor shaft 2 to rotate. For reasons of clarity, in FIG. 38 only the two toothing systems N_{K2} and N_{W} are indicated since the other toothing pair N_{K1} with N_{G} lies geometrically in a different plane. The converter 3 is rotatably mounted by means of bearing means 9 in a drive ring 4. The bending actuators 5.1, 5.2 are fixed in the motor housing 1 at their foot-side end. By applying electric signal voltages to the connecting lines 7.1, 7.2 of the bending actuators 5.1, 5.2, the latter are made to carry out movements at their opposite end which are proportional to the signal voltages. The bending actuators are oriented in such a way that they carry out movements mainly in the xy plane which lies perpendicularly with respect to the motor shaft axis I-I′. In FIG. 38, the direction of movement of the bending actuator ends is clarified symbolically by arrows. In the case of piezo-electric bending actuators, the amplitudes of these movements can typically lie in the region of approximately ±500 μm. The bending actuators are rotated in FIG. 38 in the xy plane by an angle of 90 degrees with respect to one another. By applying periodic, preferably sinusoidal, signal voltages to the two bending actuators 5.1 and 5.2 with a preferable phase offset of 90 degrees, these are made to carry out with respect to one another mechanical deflections which have a phase offset of 90 degrees and which transmit to the drive ring 4 via the compression struts 6.1 and 6.2 which are resistant to compression but resilient, and said deflections are superimposed to form a circular shifting movement of the drive ring 4 about the axis of the motor shaft 2. As a result, the toothing systems N_{K1} and N_{K2} of the converter 3 roll in the toothing system N_{G} of the motor housing and N_{W} of the motor shaft 2, as a result of which the motor shaft 2 is made to rotate. Instead of the compression struts 6.1 and 6.2, other kinematic structures such as connecting links, joints etc. (not explained here in detail) are also suitable for disruption-free superimposition of the individual movements of the at least two bending actuators 5.1, 5.2. Rotary drives of the type shown in FIG. 38 are suitable, in particular, for planar motors and miniaturized actuator drives. The rotary drive can be miniaturized, in particular, by means of (micro)injection molding in plastic or metal or by micro-mechanical manufacturing methods, for example as MEMS, wherein instead of piezo-electric bending actuators it is also possible to use other actuator principles such as electro-static comb drives.

According to the prior art, cylindrical electric motors are widespread. FIG. 39 shows a cylindrical rotary drive of the type according to the invention, having four bending actuators 5 as drive elements for the converter 3. The rotary drive has four drive units P1, P2, P3, P4, analogous to the stator poles of the electro-magnetic rotary drives which are oriented along the motor shaft axis I-I′ and are each rotated by 90° with respect to one another. Each drive unit has the elements of the holder H1 having or composed of the holder segment H1.1 and the holder segment H1.2, the bending actuator 5 with electrical contact faces 9 and electrical connecting lines 7 and an end cap G1 having the end cap segment G1.2 and the transmission segment G1.2. The main directions of action, the movements of the bending ends at the end facing the converter 3 being referred to as such, lie within the xy plane. In order to superimpose the directions of action of the individual bending actuators without disruption, the holders H1, H2, H3, H4 have a two-part design, as illustrated in FIG. 40. The bending actuator 5 is held in a fork-shaped holder segment H1.2 in which it is, for example, bonded in, pressed in, soldered or welded. The holder segment H1.1 has a flat thin material or is composed thereof and is rotated by 90° with respect to the holder segment H1.2 and connected thereto or manufactured from one piece. By the other end the holder segment H1.1 is permanently connected to the motor housing 1. This results in the cross-shaped structure of the holders H which can be seen in FIG. 40. In order to generate bending forces which are large on the converter side, a base-point-side attachment of the bending actuator to the motor housing 1 which is as rigid as possible is to be aimed at. However, this would impede the movement of the adjacent bending actuators which are rotated through 90 degrees. For this reason, the holders H are embodied in such a way that they connect the bending actuator rigidly to the motor housing in the main direction of movement of said bending actuator, but said holders H behave as flexibly as possible in the direction perpendicular to said main direction of movement. This can be achieved by means of the structure of the holder (illustrated in FIG. 39 and FIG. 40) in the form of a thin bending plate which offers only a very small resistance to the movement of the two adjacent bending actuators but connects the bending actuator rigidly to the motor housing at the base point side in the main direction of action of said bending actuator. Instead of the bending plates, the base-point-side holders H1 can also be embodied in the form of pins which are attached opposite one another on the broadsides of the bending actuators. At their converter-side end, the bending actuators are connected to end caps G1, G2, G3, G4 whose fork-shaped sections G1.1, G2.1, G3.1, G4.1 receive the bending actuators. The bending actuators are mechanically connected to the drive ring 4 via the transmission segments G1.2, G2.2, G3.2, G4.2. The transmission segments are embodied in such a way that they ensure parallel shifting of the drive ring 4 when the drive units P1, P2, P3, P4 are actuated. For this purpose, the transmission segments can have, for example, a pin-shaped form. The drive ring 4 is rotatably mounted in the converter 3 by means of bearing means 11. The converter 3 has the two toothing systems N_{K1} and N_{K2} which can roll in toothing systems N_{G} of the motor housing and N_{W} of the disk-shaped region 10 of the motor shaft 2, as a result of which the motor shaft 2 is made to rotate. The motor shaft 2 is rotatably mounted in the motor housing 1 by means of bearing means 8. In order to better accommodate the radial forces applied to the motor shaft 2 by the converter 3, the motor shaft can have multiple mounting, as illustrated in FIG. 39. In order to operate the rotary drive, in each case bending actuators lying opposite one another are actuated electrically in such a way that the converter-side ends move synchronously in the same direction. The two bending actuator pairs formed in this way are actuated with respect to one another with a phase offset of preferably 90 degrees in the configuration illustrated in FIG. 39 and FIG. 40. As a result, the individual movements of the bending actuators are superimposed to form a circular shifting movement of the converter 3 whose toothing systems N_{K1} and N_{K2} roll as a result in the toothing systems N_{G} of the motor housing 1 and N_{W} of the motor shaft 2 and make the motor shaft rotate. The cylindrical rotary drive illustrated in FIG. 39 and FIG. 40 with four bending actuators is only by way of example. There are no restrictions on the number of drive units or the bending actuators and cascading.

Since all the designs of electromagnetic rotary drive variants can also be produced by means of solid-state actuators or other actuators, a detailed explanation will not be given.

The drive principle according to the invention permits electrically controllable rotary drives with high transmission ratios in a small space, high torques, a high level of positioning accuracy and a high level of dynamics with a comparatively simple design.

All the forms of known electrical and non-electrical actuators are suitable as drive actuators for the converter.

Means which assist the mechanical guidance of the converter and/or bring about forcible guidance of the converter can be provided for all rotary drives of the type according to the invention, with the result that in every operating state the toothing systems are in secure engagement. In addition to mechanical means, such as, for example, eccentrics or connecting links, in particular magnetic means are suitable for this. In so far as the stator means P1, PX do not already themselves provide a sufficient engagement force of the toothing systems, further active and passive means, in particular magnet means, may be present in order to boost the engagement force. As is shown by FIG. 41, the magnet means 13, 14 may be arranged on the circumference (on the inside and/or outside) of the converter 3 in such a way that they assist or boost the engagement forces of the toothing systems generated by the stator means P1, PX. The magnet means have, for example, a ring or a disk 12 or are composed thereof, magnetic poles 13 (south poles) and 14 (north poles) being alternatively arranged on the circumference of said ring or disk 12. The converter 3 is composed, at least in these areas, of ferromagnetic material or has such a material. In particular, the main direction of action of the magnet means acting on the converter 3 is radially with respect to the motor shaft axis I-I′. The converter 3 carries out a tumbling movement about the axis of the motor shaft I-I′, during which tumbling movement the angular position of the minimum distance of the converter 3 from the stator means rotates, while the rotary drive is running, about the axis of the motor shaft I-I′ and/or can assume any angular position, for example even when the motor shaft of the rotary drive is stationary. In particular, for this reason permanent magnets are suitable as magnetic means for assisting the engagement force of the toothing systems since such magnet means generate larger forces in the region of a short distance, xmin in FIG. 41, from a ferromagnetic object, for example the converter 3 or ferromagnetic regions of the converter 3 than in the region of a relatively large distance, xmax in FIG. 41, and therefore increase the engagement force of the toothing systems in the desired way. The magnet means can, for example, have a disk or a ring with a multiplicity of radially arranged permanent magnets or radially magnetized material or electromagnets or be composed thereof.

In particular, the rotary drives of the type according to the invention can have toothing systems in which the difference in the number of teeth of the first toothing system of the converter N_{K1} with respect to the number of teeth of the toothing system of the motor housing N_{G} is one and/or the difference in the number of teeth of the second toothing system of the converter N_{K2} with respect to the number of teeth of the toothing system of the motor shaft N_{W} is one.

In particular, the rotary drives of the type according to the invention can have cycloidal tooth shapes and/or evolvent tooth shapes for the toothing systems N_{K1}, N_{K2}, N_{G} and N_{W}.

FIG. 42 shows in a detailed illustration the basic variants of the rotary drive illustrated in FIG. 3.

The variants illustrated in FIG. 42 each have a first body 1, a second body 2 and a third body 3. The body 1 and the body 2 are arranged coaxially with respect to a common rotational axis I-I′ and mounted rotatably. The rotational bearings are not illustrated in FIG. 42. The body 1 has the toothing system N_{G}, the body 2 has the toothing system N. The toothing systems N_{G} and N_{W} are coaxial with respect to the rotational axis I-I′. The body 3 has two toothing systems N_{K1}, N_{K2}, wherein the center points of the pitch circles of the toothing systems N_{K1}, N_{K2} lie on a rolling axis J-J′. The toothing system N_{K1} can roll in the toothing system N_{G}, and the toothing system N_{K2} can roll in the toothing system N_{W}. The rolling axis J-J′ has an eccentricity e with respect to the rotational axis I-I′.

The actuators which can apply forces acting on the body 3 in the plane perpendicular to the rotational axis I-I′ are not illustrated in FIG. 42 for reasons of clarity. Eccentrics which may be present in order to forcibly guide the body 3 in a rotationally shiftable fashion, but do not input any energy into the system, are not illustrated in FIG. 42 for the same reason.

Forces acting perpendicularly to the rotational axis I-I′ in the plane and which shift the body 3 eccentrically about the rotational axis I-I′ can be applied to the body 3 by actuators, wherein the axis J-J′ of the body 3 moves about the rotational axis I-I′ on a circular path with the eccentricity e. In this context, the toothing system N_{K1} rolls in the toothing system N_{G}, and the toothing system N_{K2} rolls in the toothing system N_{W}, as a result of which the body 1 is made to rotate about the rotational axis I-I′ with respect to the body 2. The power of the rotary drive branches to body 1 and to body 2.

If one of the bodies 1 or 2 is secured in a rotationally fixed fashion, for example by being connected to a carrier structure (housing), the power of the rotary drive is completely output to the other body which becomes the (motor) shaft.

If the body 1 is assumed to be rotationally fixed in that it is connected to a carrier structure, this carrier structure is referred to as the housing 1, and the body 2 is referred to as the shaft 2.

The toothing system pairing formed from the toothing system of the first body and the first toothing system of the third body (converter), forms a first converter stage (transmission stage).

The toothing system pairing formed from the toothing system of the second body and the second toothing system of the third body (converter) forms a second converter stage (transmission stage).

The basic variants shown in FIG. 42 have, in particular, the following features and properties:

FIG. 42.1: The toothing system N_{K1} is an internal toothing system and the toothing system N_{K2} is an external toothing system: the rotational speeds of the two converter stages are added. The rotational direction of the shaft 2 is the same as the direction of rotation of the shifting of the converter 3.

FIG. 42.2: The toothing system N_{K1} is an external toothing system and the toothing system N_{K2} is an internal toothing system: the rotational speeds of the two converter stages are added. The rotational direction of the shaft 2 is opposed to the direction of rotation of the shifting of the converter 3.

FIG. 42.3: The toothing systems N_{K1} and N_{K2} are both internal toothing systems: the rotational direction of the first converter stage is in the same direction as that of the direction of rotation of the electrical energization pattern, and the rotational direction of the second converter stage is opposed to the direction of rotation of said electrical energization pattern. The rotational speeds of the two converter stages are opposed. The resulting rotational direction of the shaft 2 depends on the relationship of the transmission ratio of the first converter stage with respect to that of the second converter stage, and can be both in the same direction as the direction of rotation of the shifting of the converter 3 as well as opposed thereto.

FIG. 42.4: Both toothing systems N_{K1} and N_{K2} are external toothing systems: the rotational direction of the first converter stage is opposed to the direction of rotation of the electrical energization pattern, and the rotational direction of the second converter stage is in the same direction as the direction of rotation of said electrical energization pattern. The rotational speeds of the two converter stages are opposed. The resulting rotational direction of the shaft 2 depends on the relationship of the transmission ratio of the first converter stage with respect to that of the second converter stage, and can therefore be in the same direction as the direction of rotation of the shifting of the converter 3 as well as opposed thereto.

FIG. 43 shows a further exemplary embodiment of a rotary drive having power splitting to two shafts 2, 4.

In this context, the first body and the second body are rotatably mounted in a carrier structure 1 (housing).

The rotatably mounted first body constitutes the shaft in FIG. 43. The rotatably mounted second body constitutes the shaft 2 in FIG. 43. Both shafts are mounted coaxially in the housing 1 with respect to a rotational axis I-I′ by means of bearing means 8. The shaft 4 has the toothing system N_{G}. The shaft 2 has the toothing system N. The converter 3 has two toothing systems N_{K1} and N_{K2} which are arranged coaxially with respect to a rolling axis J-J′. The rolling axis J-J′ has an eccentricity e with respect to the rotational axis I-I′. The toothing system N_{K1} of the converter 3 can roll in the toothing system N_{G} of the shaft 4, and the toothing system N_{K2} of the converter 3 can roll in the toothing system N_{W} of the shaft 2. The entire converter 3 can therefore roll in the toothing systems in an eccentrically rotating fashion. The eccentricity of the rolling axis of the converter J-J′ with respect to the rotational axis I-I′ of the shafts is e. Equation (1) can continue to be applied, wherein Ω specifies in this case the rotational speed and the rotational direction of the shaft 2 in relation to the shaft 4.

If both shafts 2, 4 are output shafts on which external load torques can engage, the rotary drive shown in FIG. 43 has properties of an electrically driven differential, i.e. the electro-mechanical power of the rotary drive is distributed between both output shafts. If, for example, the shaft 2 is fixed with respect to the housing 1, the entire drive power is transmitted to the shaft 4. Conversely, when the shaft 4 is fixed the entire power is transmitted to the shaft 2. If load torques act on both shafts, the drive power of the rotary drive is divided between both shafts. The principle of the power splitting to two shafts is applicable to all designs and variants of the rotary drive according to the invention covered by this application, for which purpose the first body and the second body are rotatably mounted and embodied as shafts. Therefore, the different variants are not treated separately. However, in the case of the rotary drive illustrated in FIG. 43, one of the shafts can also be an (externally driven) input shaft and the respective other shaft can also be an output shaft (output shaft). For this purpose, the input shaft can be driven directly or indirectly by means of mechanical transmission means such as, for example, a chain, a toothed belt or by any other drive, for example an electric motor, an internal combustion engine, by wind power, by hydraulic forces or by water forces, and the output shaft can drive a load, for example the camshaft of a motor vehicle, a compressor or a generator. If the input shaft rotates with the mechanical rotational frequency ω_{E}, by phase-synchronous actuation of the actuators, like the electromagnets with the magnetic poles P1, PX illustrated in FIG. 43 having or composed of the coil 7.X, core 5.X and pole shoe 6.X, with the electrical rotational frequency ωₑ₁=ω_{E} it is possible to bring about a phase-rigid coupling of the input shaft to the output shaft, during which the output shaft moves with the same rotational frequency as the input shaft. The mechanical power of the input shaft of the rotary drive is transmitted here to the output shaft by the positively engaging connection of the input shaft to the output shaft via the converter 3. In order to detect the input shaft rotational speed and/or the output shaft rotational speed, the rotary drive can have sensor means, for example Hall sensors, encoders and electrical evaluation and actuation means (actuation electronics and software for controlling movement) (not illustrated in FIG. 43), or the position information and/or load information is extracted from the electrical variables of the actuators. By increasing or decreasing ωₑ₁ with respect to the mechanical rotational frequency ω_{E}, it is possible to set positive or negative differential rotational speeds between the input shaft and output shaft. The differential rotational speed can be configured in a chronologically variable fashion through frequency modulation and/or phase modulation of ωₑ₁. For example, through periodic frequency modulation and/or phase modulation of ωₑ₁ it is possible to carry out periodic adjustment in the advanced direction and/or retarded direction of the output shaft with respect to the input shaft in terms of the mechanical phase of ω_{E}. The rotary drive shown in FIG. 43 can therefore carry out the function of a phase shifter. Such phase shifters are used, for example for camshaft adjustment in motor vehicle internal combustion engines in order to control inlet valves and outlet valves as a function of the characteristic diagram. In particular, the main drive power of the output shaft of the rotary drive is made available here by the input shaft, while the rotary drive makes available the power required to maintain the positive engagement and to adjust the output shaft with respect to the input shaft. In order to assist the positively engaging force flux between the shafts 2, 4 and the converter 3, the converter 3 can be mounted in such a way that it can be rotated with respect to revolutions about the axis J-J′ and moved eccentrically with respect to the axis I-I′, for example using an eccentric. The power demand for the eccentric is low since the latter is entrained. In addition, the eccentric can serve, through suitable mass distribution, to compensate the imbalance caused by the eccentric movement of the converter. The input shaft and output shaft can be interchanged in their function, i.e. each of the shafts 2, 4 in FIG. 43 can serve as an input shaft or output shaft.

FIG. 44 shows perspective views of a rotary drive, its functional elements and the arrangement thereof. FIG. 44a shows the assembled rotary drive with, inter alia, the housing 1, shaft 2 and bearing means 8 for the shaft 2. FIG. 44b shows the stator 5 with the coil windings 7 of the electromagnets as well as a ring 3.3 of the converter 3 made of ferromagnetic material. FIG. 44c shows the stator 5 with the converter 3 inserted, in a front view, and in a rear view in FIG. 44d. As illustrated in FIG. 44f, the converter 3 can be constructed from a ferromagnetic ring 3.3, a hollow axle 3.4 as well as two gearwheels 3.1 and 3.2. The constructed design permits the manufacture of the converter, and materials which are adapted to the requirements can be used.

For this purpose, the elements 3.1, 3.2, 3.3, 3.4 are mechanically connected to one another. The converter 3 which is formed in this way has the gearwheel 3.2 with the external toothing system N_{K2}, which can roll in the shaft toothing system N_{W}, see FIG. 44c. The gearwheel 3.1 of the converter 3 has the external toothing system N_{K1} which can roll in the housing toothing system N_{G}, see FIG. 44d. The arrangement of the individual components of the rotary drive can be seen, in particular, in the sectional view FIG. 44e. The stator 5, the pole shoes 6, the coil windings 7 of the electromagnets, the hollow axle 3.4, the ring 3.3 of the converter made of ferromagnetic material, the shaft 2 and the gearwheels 3.1, 3.2 are partially visible. As shown in FIG. 44g, the converter 3 can be guided through an eccentric 9 which is mounted on the shaft 2. In order to compensate for the imbalance, the eccentric 9 has an asymmetrical mass distribution with respect to its rotational axis, formed by the mass 16 and the cutout 15, with the result that the center of gravity of the eccentric is opposite the center of gravity of the converter with respect to the rotational axis. The eccentric 9 is rotatably mounted by its internal surface 9.1 on the shaft 2 and by its external surface 9.2 in the hollow axle 3.4 of the converter 3.

A rotary drive of an example according to the invention can have, in particular:
at least one motor shaft with at least one toothing system,
a motor housing with at least one toothing system or a motor housing without toothing system with a second motor shaft with at least one toothing system,
an element which can move in the radial direction with respect to the motor shaft axis and has at least two toothing systems which are arranged concentrically with respect to one another and which can roll in the toothing systems of the motor housing and of the motor shaft,
an arrangement of the moveable element between the motor shaft and motor housing which permits an eccentric rotational movement,
switchable stator means for generating mechanical forces acting on the moveable element,
means for actuating the switchable stator means,
means for detecting the electrical variables of the switchable stator means,
means for detecting the position of the moveable element.

The drive principle according to the invention permits electrically controllable rotary drives with high transmission ratios in a small space, high torques, a high level of positioning accuracy and a high level of dynamics with a comparatively simple design.

1. A rotary drive comprising:
a first body which has a toothing system of the first body, which toothing system runs around along a first circular circumference about a first rotational axis;
a second body which has a toothing system of the second body, which toothing system runs around along a second circular circumference about the first rotational axis; and
a converter which has a first toothing system of the converter, which first toothing system runs around along a circular circumference at a first spacing about a second rotational axis, and a second toothing system of the converter, which second toothing system runs around coaxially with respect to the first toothing system along a circular circumference at a second spacing,
wherein the second rotational axis is parallel to the first rotational axis and spaced apart therefrom,
and having at least two actuators with directions of action which are not parallel to one another, by which the converter can be shifted in each case in one direction,
wherein the first toothing system of the converter is in engagement in a first engagement region with the toothing system of the first body,
wherein the second toothing system of the converter engages in a second engagement region with the toothing system of the second body, and wherein the converter can be shifted in one direction in each case by the at least two actuators, in such a way that the second rotational axis runs around along a circular path about the first rotational axis.

2. The rotary drive as claimed in claim 1, wherein the first distance is unequal to the second distance.

3. The rotary drive as claimed in claim 1, wherein the toothing system of the first body is an internal toothing system, and the first toothing system of the converter is an external toothing system, or the toothing system of the first body is an external toothing system and the first toothing system of the converter is an internal toothing system and/or the toothing system of the second body is an internal toothing system and the second toothing system of the converter is an external toothing system or the toothing system of the second body is an external toothing system and the second toothing system of the converter is an internal toothing system.

4. The rotary drive as claimed in claim 1, having a carrier structure,
wherein the at least two actuators are permanently connected to the carrier structure and/or either the first or the second body are/is permanently connected to the carrier structure and/or are/is part of the carrier structure.

5. The rotary drive as claimed in claim 1, having a carrier structure, wherein the at least two actuators are permanently connected to the carrier structure,
and the first body and the second body can be rotated with respect to the actuators.

6. The rotary drive as claimed in claim 1, wherein in each case a shaft is connected to the first body and/or to the second body or the first and/or the second bodies are/is each part of a shaft.

7. The rotary drive as claimed in claim 1, wherein as a result of the action of each of the actuators the converter can be moved in each case only in that direction in which the corresponding actuator acts.

8. The rotary drive as claimed in claim 1, having at least one eccentric which can run around the first rotational axis and is arranged in such a way that it blocks a movement of the converter and/or a rotary hearing of the converter in a direction which is radial with respect to the first rotational axis and by which the toothing system of the first body and/or of the second body would be disengaged from the corresponding toothing system of the converter.

9. The rotary drive as claimed in claim 8, wherein the eccentric has a contact region which runs around the outside and is in contact with a contact region of the converter which runs around the inside, at least in a region which is arranged radially in relation to the first rotational axis in the same direction or in the opposite direction to the first and/or the second engagement regions,
or wherein the eccentric has a contact region which runs around the inside and is in contact with a contact region of the converter which runs around the outside, at least in a region which is arranged radially in relation to the first rotational axis in the same direction or in the opposite direction to the first and/or the second engagement regions.

10. The rotary drive as claimed in claim 8, wherein the eccentric is a plate, preferably a disk, ring or cylinder, which is mounted so as to be rotatable about the first rotational axis and whose axis of symmetry is offset with respect to the first rotational axis radially in relation to the first rotational axis in the direction of the first engagement region or away from the first engagement region and/or in the direction of the second engagement region or away from the second engagement region.

11. The rotary drive as claimed in claim 1, having at least one balancing mass which is arranged in such a way that its center of gravity is radially opposite a center of gravity of the converter in every position of the converter in relation to the first rotational axis
or is radially in the same direction as the center of gravity of the converter.

12. The rotary drive as claimed in claim 8, wherein a center of gravity of the eccentric lies radially opposite a center of gravity of the converter in every position of the converter relative to the first rotational axis or lies in the same direction as the center of gravity of the converter.

13. The rotary drive as claimed in claim 1, wherein the actuators each apply a force directly to the converter.

14. The rotary drive as claimed in claim 1, wherein the actuators each apply a force on an axle lying on the second rotational axis or on a rotary bearing of the converter which lies on the second rotational axis and on which the converter is rotatably mounted.

15. The rotary drive as claimed in claim 1, wherein the actuators can each give rise to a linear force in precisely one direction.

16. The rotary drive as claimed in claim 1, wherein the actuators are electrically controllable solid-state actuators, piezo-electric actuators, magneto-strictive actuators, dielectric actuators, electro-active polymer actuators (EAP), magneto-elastic actuators, electro-magnetic actuators, electro-dynamic actuators electromagnets, electro-static actuators, electro-static comb actuators, solid-state actuators, bimetal actuators and/or actuators with at least one coil and at least one core.

17. A rotary drive, wherein a converter has a ferromagnetic material or is at least partially composed of such a material.

18. The rotary drive as claimed in claim 1, wherein at least two of the toothing systems which engage one in the other form a cycloid tooth pairing and/or an evolvent tooth pairing.

19. A method for operating a rotary drive as claimed in claim 1, wherein the actuators are actuated and/or energized to rotate in such a way that they give rise to a force which rotates about the first rotational axis and acts on the converter and/or a rotary bearing of the converter.

20. The method as claimed in claim 19, wherein in each case an attracting and/or repelling force is applied by the actuators to the converter and/or the rotary bearing.

21. The method as claimed in claim 19, wherein at a given time in each case precisely one actuator is active and/or a plurality of actuators are fully active and/or a plurality of actuators are active in a phase-offset fashion.

22. The method for operating a rotary drive as claimed in claim 19, wherein at a given point in time in each case precisely one actuator is energized, or wherein the actuators are energized with sinusoidal current profiles, wherein the rotary drive has at least three actuators which are arranged perpendicularly to the rotational axis with respect to the plane and symmetrically with respect to the rotational axis, wherein adjacent actuators are energized with current of adjacent phases, and wherein a phase difference between two adjacent phases is 360° divided by the number of actuators.

23. A method for detecting load torques in a rotary drive as claimed in claim 1, wherein a load torque is determined between the first body and a carrier structure and/or the second body and the carrier structure and/or between the first and the second body in that amplitudes and/or phase relationships between the electrical variables of the current, voltage and/or charge of the actuators are detected by electronic evaluation means and/or by evaluating electrical inductances, electrical capacitances and/or electrical resistances of the actuators.

24. A method for detect ng the rotational speed and/or position and/or detecting the attitude of a rotary drive as claimed in claim 1, wherein the rotational speed and/or the position and/or the attitude of the converter is detected with respect to a carrier structure and/or of the first body and/or of the second body with respect to the carrier structure and/or of the bodies with respect to one another by evaluating the amplitudes and/or phase relationships between the electrical variables of the current, voltage and/or charge of the actuators by electronic evaluation means and/or by evaluating electrical inductances, electrical capacitances and/or electrical resistances of the actuators.

25. A method for detecting the rotational speed and/or position and/or load torque of a rotary drive as claimed in claim 1, having sensors for detecting the rotational speed and/or position and/or attitude and/or load torque of the converter with respect to a carrier structure and/or of the first body and/or of the second body with respect to the carrier structure and/or of the bodies with respect to one another.
